(19) United States
(12) Patent Application Publication
(10) Pub. No.: US 2017/0245492 A1
(43) Pub. Date: Aug. 31, 2017

(54) AGROCHEMICAL DELIVERY SYSTEM BASED ON ENZYME- OR pH- RESPONSIVE AMPHIPHILIC PEG-DENDRON HYBRIDS

(71) Applicant: RAMOT AT TEL AVIV UNlVERSITY LTD., Tel Aviv (IL)

(72) Inventors: Roey Jacob AMIR, Tel Aviv (IL); Marina BUZHOR, Tel Aviv (IL); Assaf Josef HARNOY, Tel Aviv (IL); Ido ROSENBAUM, Tel Aviv (IL); Liat FRID, Tel Aviv (IL)

(21) Appl. No.: 15/509,946

(22) PCT Filed: Feb. 25, 2015
(86) PCT No.: PCT/IL2015/050213

§ 371 Date: Mar. 21, 2017

Related U.S. Application Data
(60) Provisional application No. 62/047,679, filed on Sep. 9, 2014.

(51) Int. Cl. A01N 25/28

(52) U.S. Cl. CPC A01N 25/28

(57) ABSTRACT

The present invention relates to an amphiphilic hybrid delivery system in micellar form for delivery of agrochemicals, based on a hydrophilic polyethylene glycol (PEG) polymer conjugated to a hydrophobic dendron, the dendron comprising at least one pH-dependent or enzymatically cleavable hydrophobic end group that is covalently attached to the dendron, wherein the micelle disassembles upon enzymatic or pH-dependent cleavage of the hydrophobic end group. The hydrophobic end group that is conjugated to the dendron may comprise an agrochemical, and/or the micelle may (non-covalently) encapsulate an agrochemical. The present invention further provides methods of use thereof and to a kit comprising same.

### FIELD OF THE INVENTION

The present invention relates to an enzyme- or pH-responsive amphiphilic hybrid delivery system in micellar form for delivery of agrochemicals, based on a hydrophilic polyethylene glycol (PEG) polymer conjugated to a hydrophobic dendron. The delivery system disassembles upon enzymatic trigger or pH-based stimuli. The present invention further provides methods of use thereof and a kit comprising same.

### BACKGROUND OF THE INVENTION

One of the major problems with the use of conventional herbicides is their decrease in activity due to various factors such as their photodecomposition, leaching and washing away by rain as well as evaporation or bio-degradation by microorganisms. Hence, these factors may require the application of greater amounts of herbicides for longer periods than actually needed to control the pest. The application of larger amounts of persistent herbicides is highly undesired due to their incorporation into the food chain and contamination of the environment, which may be hazardous for humans. However, less persistent herbicides with greater specificity are often ineffective in controlling weeds for prolonged times due to their lower stabilities in an aquatic environment. These herbicides have other disadvantages such as a high exposure to operators and farm workers and high cost, due to the expense of synthesis and the cost of the multiple applications necessary in view of their lower persistence. Therefore, the development of new delivery technologies, which will enable the use of smaller amounts of herbicides with little or no detrimental effect on the surrounding environment, while maintaining high biological activity is necessary for agriculture.

Polymer supported herbicides have attracted increasing interest due to their potential to allow delivery of the herbicide to the plant at controlled rates and quantities over specified time. In most of the reported formulations, the herbicides were conjugated as pedant groups to the backbone of synthetic or natural polymers. While many examples for polymer supported herbicides were reported in the literature, their synthesis often suffers from limited control over the exact number of herbicide moieties that are conjugated to the polymer. This limitation rises from both the inherited polydispersity of the polymeric carrier and from the partial functionalization of such carriers. Furthermore, the location of a pedant herbicide on a polymeric backbone can severely influence its steric environment and hence its release rate. In addition, the decoration of hydrophilic polymers with hydrophobic herbicides in a random manner may results in polymeric carriers with increased hydrophobicity, leading to poor water solubility.

Stimuli-responsive micelles have attracted increasing interest as they can disassemble and release encapsulated cargo upon external stimuli. There are various novel stimuli-responsive polymers based on respond to changes in pH, temperature, irradiated light, enzyme cleavage, redox potential and their combination. None of them teaches the use of enzymatic or pH-based stimuli-responsive nanocarrier for delivering agrochemicals. The limited reports on the enzymatic responsive micelle are in greater part based on breaking the amphiphilic block copolymer into a soluble hydrophilic polymer and an insoluble hydrophobic block.

Azagarsamy et al., 2009, J. Am. Chem. Soc. 131: 14184-14185 describes dendrimer-based amphiphilic assemblies that can noncovalently sequester hydrophobic guest molecules and release these guests in response to an enzymatic trigger. This is achieved by incorporating enzyme sensitive functionalities at the liphophilic face of the dendrons. This feature causes a change in the HLB when the enzyme is encountered, effecting disassembly and guest-molecule release. The micelles have a particle size between 100-200 nm prior to disassembly.

Ku et al., 2011, J. Am. Chem. Soc. 133: 8392-8395, studied the reversible switchable morphology of micellar nanoparticles with enzymes. The micelles are based on amphiphilic polymer-peptide block copolymer containing substrates for four different cancer-associated enzymes: protein kinase A, protein phosphatase-1, and matrix-metalloproteinases 2 and 9. Upon enzymatic cleavage a variety of morphologies of polymeric amphiphilic aggregates are formed.

Rao et al., 2013, J. Am. Chem. Soc. 135: 14056-14059 describes an amphiphilic diblock copolymer comprising PEG and polystyrene wherein an azobenzene linkage is incorporated at the junction of the two polymers. Upon cleavage of the azo-based linkage, the polystyrene fragment precipitates out of the solution and the hydrophilic PEG remains solubilized.

Rao et al. 2014, J. Am. Chem. Soc. 136, 5872-5875 describes a system comprising poly(styrene) and an enzyme-sensitive methacrylate-based polymer segment carrying azobenzene side chains. The azobenzene linkages cleave upon enzymatic activation, triggering a series of reactions that transforms the hydrophobic methacrylate polymer into a hydrophilic hydroxyethyl methacrylate structure. This leads the polymer to self-assemble into a micellar nanostructure in water.

Amir et al., 2009, J. Am. Chem. Soc. 131: 13949-13951, describes enzymatic activation of a water soluble diblock copolymer to obtain an amphiphilic diblock copolymer which self-assembles into colloidal nanostructures.

Amir et al., 2003, Angew. Chem. Int. Ed. 42: 4494-4499, describes self-immolative dendrimers, wherein a self-immolative chain fragmentation is initiated with a single cleavage of a trigger moiety at the dendritic core. This event leads to a spontaneous release of all the tail units of the dendrimer. This technology is also described in US Patent Application No. 2005/0271615, to some of the inventors of the present invention.

Gillies et al., 2004, J. Am. Chem. Soc. 126: 11936-11943 discloses a linear-dendritic block copolymers comprising poly(ethylene oxide) and either a polylysine or a polyester dendrimer wherein hydrophobic groups are attached to the dendrimer periphery by acid-sensitive cyclic acetal linkages. These copolymers form stable micelles in aqueous solution at neutral pH but disintegrate into unimers at mildly acidic pH.

de Groot et al., 2003, Angew. Chem. Int. Ed. 42: 4490-4494 discloses cascade-release dendrimers based on monomeric multiple-release building blocks. Following a single activation step at the dendritic core, a cascade of self-elimination reactions is triggered, which induces release of all the end groups attached at the dendrimer periphery.

Harnoy, A S et al., 2014, J Am Chem Soc. 136(21): 7531-4 disclose enzyme responsive amphiphilic PEG-dendron hybrids and their assembly into micellar nanoacrriers.

The aforementioned publications do not relate to the field of agrochemicals.

There is widely recognized need to develop a novel agrochemical delivery platform, which will overcome the described deficiencies and drawbacks associated with the known technologies. It is of a great environmental interest to develop a new system that will encapsulate an agrochemical in a high loading and a predicated manner. Moreover, such carrier should enable the use of smaller amounts of pesticides with little or no detrimental effect on the surrounding environment, while maintaining a high biological activity necessary to control pests. The delivery platform should remain soluble subsequent to the release of the agrochemicals.

### SUMMARY OF THE INVENTION

The present invention relates to an amphiphilic hybrid delivery system in micellar form for delivery of agrochemicals, based on a hydrophilic polyethylene glycol (PEG) polymer conjugated to a hydrophobic dendron, the dendron comprising at least one pH-dependent or enzymatically cleavable hydrophobic end group that is covalently attached to the dendron, wherein the micelle disassembles upon enzymatic or pH-dependent cleavage of the hydrophobic end group. The hydrophobic end group that is conjugated to the dendron may comprise an agrochemical, and/or the micelle may (non-covalently) encapsulate an agrochemical. The present invention further provides methods of use thereof and to a kit comprising same. The present invention is based on modular methodology for the synthesis of polymer-dendrimer hybrids as stimuli responsive herbicide delivery systems. Conjugation of enzymatically or pH-dependent cleavable groups (“innocent” or “active”) to the end groups of the dendrimer allows unprecedented control over the degree of loading and release of the active herbicides. Furthermore, the novel molecular architecture allows harnessing its highly defined structure and amphiphilic nature in order to form polymeric carriers that can self-assemble into “smart” micellar assemblies. These stimuli-responsive micelles are expected to disassemble and release their herbicide-cargo upon hydrolysis of the linkers between the dendrimer and the hydrophobic end-groups. In some embodiments, such “smart” assemblies can be further utilized to encapsulate active herbicides that cannot be conjugated to the polymer due to the lack of available functional groups on the herbicide.

In one aspect, the present invention is based on the modular design of enzyme responsive amphiphilic hybrids composed of linear PEG and a stimuli responsive dendron with pH-dependent or enzyme cleavable hydrophobic end-groups. These amphiphilic PEG-dendron hybrids self-assemble in water into micelles with a hydrophilic PEG shell and a hydrophobic core, which potentially can be utilized to encapsulate hydrophobic cargo herbicide compounds. In the presence of the activating enzyme, or upon a change in the pH, the hydrophobic end groups can be cleaved from the dendron, making it more hydrophilic. This change in amphiphilicity results in destabilization of the micellar aggregates, leading to their disassembly and release of soluble PEG-dendron hybrids and their encapsulated cargo (FIG. 1). The unique morphology of the micelles, with a highly packed PEG shell gives the micelle protecting properties such as avoidance of nonspecific activation with other proteins/proteases and leaching diminution of the encapsulated cargo.

As contemplated herein, the molecular structure is based on a dendron that radiates from the termini of a linear polymer, such as polyethylene glycol (PEG), which is a non-toxic, FDA approved polymer with high water solubility. The synthesis of the dendron utilizes orthogonal functional groups and reactions in order to achieve step efficient accelerated dendron synthesis. Possible structures of PEG-dendron hybrids based on poly ether/thio-ether backbone and covalently loaded with a herbicide (exemplified herein with the herbicide 2,4-Dichlorophenoxyacetic acid (2,4-D) as shown in Scheme 2). The 2,4-D is conjugated to the hydroxyl end-groups of the dendron through ester linkages, which can be cleaved by either pH dependent or enzymatic hydrolysis, to release the parent active herbicide 2,4-D.

The disclosed hybrid structures and their self-assembly into stimuli responsive micellar nanocarriers have great potential to be applied as delivery platform for the controlled release of agrochemicals. These agrochemicals may be either covalently bound to the end-groups of the dendron or encapsulated within the hydrophobic cores of the formed micelles, or both. Both types of loaded agrochemicals may be released from these micelle-based nanocarriers upon introduction of the activating stimuli which would lead to the disassembly of the micelles and release of the encapsulated agrochemicals. These responsive nanocarriers can have great potential due to their ability to release a combination of agrochemicals in a highly controlled manner.

The novel amphiphilic hybrid delivery systems of the present invention are particularly advantageous as their synthesis as well as their loading is highly efficient and simple. The modular design of these systems allows fine tuning the generation number and linkage chemistries to account for loading capacity and binding of various functional groups, respectively. Moreover, the use of a monodisperse dendron and covalent binding as a major loading approach allow high and reproducible loading capacity. Moreover, disassembly of the micelle and release rates of the agrochemical agents can be adjusted by rational tuning of structural parameters of the nanoparticles (such as hydrophilicity and length of the linear polymer, dendron generation, number of cleavable moieties, linkage chemistry and polymer/dendron weight ratio) as well as the stimuli cleavable moiety parameters (i.e., enzyme specificity, amount of enzyme, incubation time, amount of pH adjusting agent, strength of the pH agent).

The spherical nanocarriers disclosed herein possess beneficial structural and physical attributes including well-defined molecular and supermoleculare structure, monodispersity, specific size, thermodynamic stability, encapsulation ability, and water solubility. As the released polymer-dendron is highly hydrophilic, it can be easily washed away after the delivery of the active cargo. In addition, these delivery platforms do not require the use of additional surfactants or surface-active materials in order to solubilize the hydrophobic agrochemicals as the hybrid structures function as macromolecular surfactants.

According to one aspect, the present invention provides amphiphilic hybrid delivery system in micellar form for the delivery of agrochemicals, comprising a hydrophilic polyethylene glycol (PEG) polymer conjugated to a hydrophobic dendron, the dendron comprising at least one pH-dependent or enzymatically cleavable hydrophobic end group that is covalently attached to the dendron, wherein the micelle comprises an agrochemical either as part of the hydrophobic end group, or encapsulated within the micelle, or both, and wherein the micelle disassembles to release the agrochemical upon enzymatic or pH-dependent cleavage of the hydrophobic end group. In some embodiments, the micelle has an average particle size of less than about 100 nm, preferably about 50 nm or lower, more preferably about 10 nm to 50 nm, and most preferably about 10 nm to 20 nm. Each possibility represents as separate embodiment of the present invention.

According to some embodiments, the dendron comprises a plurality of hydrophobic end groups.

According to some embodiments, the hydrophobic end group is present at one or more of the terminal repeating units (i.e., terminal generations) of the hydrophobic dendron, and/or in intermediary generations of the dendron. According to some embodiments, the hydrophobic dendron comprises a first generation which is covalently bound to the PEG polymer, directly or through a linker moiety/branching unit, and comprises at least one functional group capable of binding to a further generation or to said cleavable moiety; and optionally, at least one additional generation which is covalently bound to said first generation or preceding generation and optionally to a further generation, wherein each of said optional generations comprises at least one functional group capable of binding to said first generation, to a preceding generation, to a further generation, and/or to said hydrophobic end group, each of said bonds being formed directly or through a linker or branching unit.

According to certain embodiments, each generation of the hydrophobic dendron comprises a linear or branched C1-C20 alkylene, C2-C20 alkenylene, C2-C20 alkynylene or arylene moiety which is substituted at each end with a group selected from the group consisting of —O—, —S—, —NH—, —C(═O)—, —C(═O)—O—, —O—C(═O)—O—, —C(═O)—NH—, —NH—C(═O)—NH—, —NH—C(═O)—O—, —S(═O)—, —S(═O)—O—, PO(═O)—O—, and any combination thereof. Each possibility represents as separate embodiment of the present invention.

According to other embodiments, each generation of the dendron is derived from a compound selected from the group consisting of HX—CH₂—CH₂—XH, HX—(CH₂)₁₋₃—CO₂H, and HX—CH₂—CH(XH)—CH₂—XH wherein X is independently at each occurrence NH, S or O. In one currently preferred embodiment, the dendron is derived from a compound selected from the group consisting of HS—CH₂—CH₂—OH, HS—(CH₂)₁₋₃—CO₂H and HS—CH₂—CH(OH)—CH₂—OH. Each possibility represents as separate embodiment of the present invention.

The hydrophobic dendron of the present invention comprises a preferred number of generations in the range of 0 to 5, more preferably 0 to 3. In one embodiment, the hydrophobic dendron is a generation 0 (G0) dendron. In another embodiment, the hydrophobic dendron is a generation 1 (G1) dendron. In another embodiment, the hydrophobic dendron is a generation 2 (G2) dendron. In yet another embodiment, the hydrophobic dendron is a generation 3 (G3) dendron.

According to some embodiments, the PEG has an average molecular weight between about 0.5 and 40 kDa, e.g., 2 kDa, 5 kDa and 10 kDa. Preferably, the PEG has at least 10 repeating units of ethylene glycol monomers.

According to some embodiments, the hybrid delivery system further comprises a linker moiety and/or a branching unit which connects the PEG polymer to the first generation dendron, and/or forms a part of the first generation, and/or connects between dendron generations. In one embodiment, the linker moiety and/or the branching unit is selected from a group consisting of a substituted or unsubstituted acyclic, cyclic or aromatic hydrocarbon moiety, heterocyclic moiety, a heteroaromatic moiety or any combination thereof. Each possibility represents as separate embodiment of the present invention. In one currently preferred embodiment, the linker moiety/branching unit is a substituted arylene which may be positioned between the PEG and the first generation or may form a part of the first generation, or alternatively may be positioned at one or more intermediary generations of the dendron. The branching unit may in some cases impart functionality (e.g., UV absorbance or other desired properties). Each possibility represents a separate embodiment of the present invention.

According to various embodiments, each of the linker moiety/branching unit may be connected to the PEG or to other dendron generations through a functional group selected from the group consisting of —O—, —S—, —NH—, —C(═O)—, —C(═O)—O—, —OC(═O)—O—, —C(═O)—NH—, —NH—C(═O)—NH—, —NH—C(═O)—O—, —S(═O)—, —S(═O)—O—, PO(═O)—O—, —C═C—, —C≡C—, —(CH₂)ₜ— wherein t is an integer of 1-10, and any combination thereof. On representative example of a functional group linking the PEG to the dendron is —S—(CH₂)ₜ—NHC(O)—. Each possibility represents as separate embodiment of the present invention.

According to some embodiments, the enzymatically cleavable hydrophobic end group is conjugated to the dendron through an enzymatically cleavable functional group selected from the group consisting of an ester, an amide, a carbamate, a carbonate, a urea, a sulfate, an amidine, an ether, a phosphate, a phosphoamide, sulfamates, and a trithionate. Each possibility represents as separate embodiment of the present invention. According to some embodiments, the enzymatically cleavable hydrophobic end group is conjugated to the dendron through an amide which is cleavable by an amidase. In one embodiment, the amidase is selected form the group of aryl-acylamidase, aminoacylase, alkylamidase, and phthalyl amidase. Each possibility represents as separate embodiment of the present invention.

According to some embodiments, the enzymatically cleavable hydrophobic end group is conjugated to the dendron through an ester which is cleavable by an esterase. In one embodiment, the esterase is selected from the group consisting of carboxylesterase, arylesterase, and acetylesterase. Each possibility represents as separate embodiment of the present invention.

According to other embodiments, the hydrophobic end group is cleaved by an enzyme which is (i) present in greater amount at; or (ii) produced in greater quantity at, or (iii) has higher activity at the delivery site of said agrochemical. Each possibility represents as separate embodiment of the present invention.

According to some embodiments, the hydrophobic end group is hydrolyzed upon a change in the pH in the environment surrounding the delivery site of the system. In one embodiment, the hydrophobic end group is hydrolyzed in acidic pH. In another embodiment, the hydrophobic end group is hydrolyzed in neutral pH. In yet another embodiment, the hydrophobic end group is hydrolyzed in basic pH. Each possibility represents as separate embodiment of the present invention. According to some embodiments, the pH-sensitive moiety is cleaved by acid catalyzed hydrolysis or base catalyzed hydrolysis.

According to other embodiments, the pH-sensitive moiety is selected from the group consisting of an ester, an amide, an anhydride, an imide, a carbonate, a carbamate, a thiocarbamate, a urea, sulfonylurea, an acetal, a ketal, a hemiacetal, a hemiketal, an amidine, a guanidine, a silyl ether, an imine, an enamine, a hydrazone, an oxime, a phosphate, a phosphorothionate, a phosphoroamide, a sulfonamide, and a trithionate. Each possibility represents as separate embodiment of the present invention.

The pH-sensitive or enzymatically cleavable hydrophobic end group may be an “innocent” group, i.e., it is biologically inactive. Alternatively, the hydrophobic end group may itself be, or may be derived from an agrochemical which is released upon disassembly of the micelle. In either case (i.e., delivery systems containing “innocent” or “active” hydrophobic end groups), the hybrid delivery system may further comprise a second agrochemical encapsulated (non-covalently) within the micelle, wherein the second agrochemical is released upon disassembly of the micelle. The first and second agrochemicals may be the same or different. Each possibility represents a separate embodiment of the present invention.

In some embodiments, the hydrophobic end group which is covalently attached to the dendron and the agrochemical which is encapsulated within the micelle are the same, i.e., they are both derived from the same agrochemical. In another embodiment, the hydrophobic end group which is covalently attached to the dendron and the agrochemical which is encapsulated within the micelle are different, and they are both agrochemically active compounds, or they are derived therefrom. In other embodiment, the hydrophobic end group which is covalently attached to the dendron is biologically inactive, and the micelle non-covalently encapsulates an agrochemical which is released upon disassembly of the micelle.

According to some embodiments, the hydrophobic end group which is attached to the dendron and the agrochemical which is encapsulated by said micelle are each or are each derived from an agrochemical independently selected from the group consisting of acetyl CoA carboxylase inhibitors, acetolactate synthase ALS (acetohydroxyacid synthase AHAS) inhibitors, photosynthesis at photosystem II inhibitors, photosystem-I-electron diversion inhibitors, protoporphyrinogen oxidase (PPO) inhibitors, carotenoid biosynthesis at the phytoene desaturase step (PDS) inhibitors, 4-hydroxyphenyl-pyruvate-dioxygenase (4-HPPD) inhibitors, carotenoid biosynthesis inhibitors, EPSP synthase inhibitors, glutamine synthase inhibitors, DHP (dihydropteroate) synthase inhibitors, microtubule assembly inhibitors, mitosis inhibitors, cell division inhibitors, cell wall (cellulose) synthesis inhibitors, melanin synthesis in cell wall inhibitors, uncoupling disruptors, lipid synthesis inhibitors, synthetic auxins, auxin transport inhibitors, nucleic acids synthesis inhibitors, respiration inhibitors (including: mitochondrial ATP synthase inhibitors, uncouplers of oxidative phosphorylation via disruption of the proton gradient, mitochondrial complex III electron transport inhibitors, mitochondrial complex I electron transport inhibitors, mitochondrial complex IV electron transport inhibitors, and mitochondrial complex II electron transport inhibitors), amino acids and protein synthesis inhibitors, signal transduction inhibitors, sterol biosynthesis in membranes inhibitors, host plant defence induction inhibitors, acetylcholinesterase (AChE) inhibitors, GABA-gated chloride channel antagonists, sodium channel modulators, nicotinic acetylcholine receptor (nAChR) agonists, nicotinic acetylcholine receptor (nAChR) allosteric activators, chloride channel activators, juvenile hormone mimics, miscellaneous non-specific (multi-site) inhibitors, modulators of chordotonal organs, mite growth inhibitors, microbial disruptors of insect midgut membranes, nicotinic acetylcholine receptor (nAChR) channel blockers, chitin biosynthesis type 0 and 1 inhibitors, moulting dipteran disruptor, ecdysone receptor agonists, octopamine receptor agonists, voltage-dependent sodium channel blockers, ryanodine receptor modulators and any combination thereof.

According to some embodiments, the hydrophobic end group which is attached/conjugated to the dendron, and/or the compound which is encapsulated within the micelle are each independently selected from the group consisting of a pesticide, an insecticide, a herbicide, a fungicide, an acaricide, an algicide, an antimicrobial agent, biopesticide, a biocide, a disinfectant, a fumigant, an insect growth regulator, a plant growth regulator, a miticide, a microbial pesticide, a molluscide, a nematicide, an ovicide, a pheromone, a repellent, a rodenticide, a defoliant, a dessicant, a termiticide, a piscicide, avicide, rodenticide, bactericide, insect repellent, an auxin, a cytokinin, a gametocide, a gibberellin, a growth inhibitor, a growth stimulator and any combination thereof, or a moiety derived from said agents. Each possibility represents as separate embodiment of the present invention.

In one embodiment, the insecticide is selected from the group consisting of a benzoyl urea, novaluron, lufenuron, chlorfluazuron, flufenoxuron, hexaflumuron, noviflumuron, teflubenzuron, triflumuron, diflubenzuron; a carbamate, a pyrethroid, cyhalothrin and isomers thereof, lambda-cyhalothrin, deltamethrin, tau-fluvalinate, cyfluthrin, beta-cyfluthrin, tefluthrin, bifenthrin; an organophosphate, azinfos-methyl, chlorpyrifos, diazinon, endosulfan, methidathion; a neonicotinoid, a phenylpyrazole, imidacloprid, acetamiprid, thiacloprid, dinotefuran, thiamethoxam and fipronil;

In another embodiment, the fungicidally active compound is selected from the group consisting of a conazole, epoxiconazole, hexaconazole, propiconazole, prochloraz, imazalil, triadimenol, difenoconazole, myclobutanil, prothioconazole, triticonazole, tebuconazole, a morpholine, dimethomorph, fenpropidine fenpropimorph, a strobilurin, azoxystrobin, kresoxim-methyl, phthalonitriles, chlorothalonil; mancozeb; fluazinam; a pyrimidine and bupirimate;

In yet another embodiment, the herbicide is selected from the group consisting of an aryloxyphenoxy derivative, an aryl urea, an aryl carboxylic acid, a heteroaryl carboxylic acid, an aryloxy alkanoic acid, clodinafop-propargyl, fenoxaprop-p-ethyl, propaquizafop, quizalafop, a dintroaniline, pendimethalin, trifluralin; a diphenyl ether, oxyfluorfen, an imidazolinone, a sulfonylurea, chlorsulfuron, nicosulfuron, rimsulfuron, tribenuron-methyl, a sulfonamide, a triazine, a triazinone and metamitron. Each possibility represents as separate embodiment of the present invention.

In a currently preferred embodiment, the hydrophobic end group which is attached/conjugated to the dendron, and/or the compound which is encapsulated within the micelle are each independently selected from the group consisting of abscisic acid, indole acetic acid, 2,4-dichlorophenoxyacetic acid, 2,4,5-trichlorophenoxyacetic acid, salicylic acid, 2,3,6-trichlorobenzoic acid, benzoylprop, carfentrazone, chlorfenprop, cloquintocet, diclofop, diethatyl, fenoxaprop, fluoroglycofen, haloxyfop, iodosulfuron, MCPB, quizalofop-p, bufencarb, ethiofencarb, fenobucarb, clofibric acid, α-naphthaleneacetic acid, gibberellic acid, jasmonic acid, and derivatives thereof. Each possibility represents as separate embodiment of the present invention.

According to some embodiments, the hybrid delivery system is represented by the structure of formula (I), which is provided in the Detailed Description hereinbelow. Specific examples of the hybrid delivery system of formula (I) are described in the Detailed Description hereinbelow.

In another aspect, the present invention provides a method of delivering the amphiphilic hybrid system comprising the step of contacting a plant or the plant surroundings with the amphiphilic hybrid delivery system described herein, and an enzyme or a pH adjusting agent in an amount effective to induce cleavage of the hydrophobic end group, thereby disassembling said micelle and releasing its cargo agrochemical.

In another aspect, the present invention provides a kit for delivering the amphiphilic hybrid system comprising in one compartment the agrochemical amphiphilic hybrid system as described herein, and in a second compartment an enzyme or a pH adjusting agent capable of hydrolyzing the hydrophobic end group so as to disassemble said micelle and release its cargo agrochemical.

The present invention will be more fully understood from the following figures and detailed description of the preferred embodiments thereof.

### BRIEF DESCRIPTION OF THE DRAWINGS

FIG. 1: Schematic representation of the self-assembly and disassembly of the micellar nanocarrier.

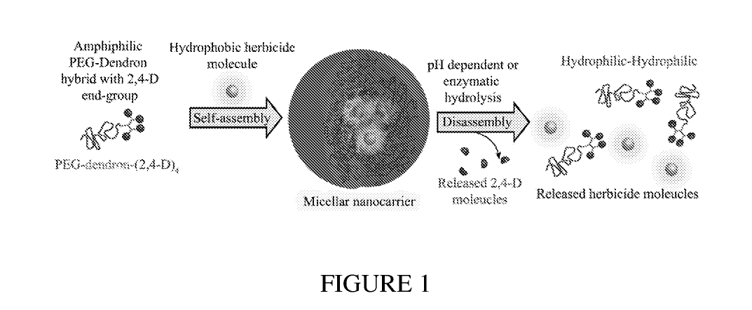

FIG. 2: Schematic representations of the possible micellar assemblies based on PEG-dendron hybrids with increasing PEG length (a) and increasing dendrons' generation (b).

FIG. 3: Chemical structures of several hybrid delivery systems according to the invention.

### DETAILED DESCRIPTION

The Amphiphilic Hybrid Delivery System

The present invention relates to an amphiphilic hybrid delivery system in micellar form for delivery of agrochemicals, based on a hydrophilic polyethylene glycol (PEG) polymer conjugated to a hydrophobic dendron, the dendron comprising at least one pH-dependent or enzymatically cleavable hydrophobic end group that is covalently attached to the dendron, wherein the micelle disassembles upon enzymatic or pH-dependent cleavage of the hydrophobic end group. The hydrophobic end group that is conjugated to the dendron may comprise an agrochemical, and/or the micelle may (non-covalently) encapsulate an agrochemical. In some embodiments, the micelle has an average particle size of less than about 100 nm, preferably about 50 nm or lower, more preferably about 10 nm to 50 nm, and most preferably about 10 nm to 20 nm. Each possibility represents as separate embodiment of the present invention.

A “dendron” is a hyper-branched monodisperse organic molecule defined by a tree-like or generational structure. In general, dendrons possess three distinguishing architectural features: a linker moiety; an interior area containing generations with radial connectivity to the linker moiety; and a surface region (peripheral region) of terminal moieties.

According to some embodiments, the dendron comprises a plurality of hydrophobic end groups.

According to certain embodiments, each generation of the hydrophobic dendron comprises a linear or branched C1-C20 alkylene, C2-C20 alkenylene, C2-C20 alkynylene or arylene moiety which is substituted at each end with a group selected from the group consisting of —O—, —S—, —NH—, —C(═O)—, —C(═O)—O—, —O—C(═O)—O—, —C(═O)—NH—, —NH—C(═O)—NH—, —NH—C(═O)—O—, —S(═O)—, —S(═O)—O—, PO(═O)—O—, and any combination thereof. Each possibility represents as separate embodiment of the present invention.

According to some embodiments, the hybrid delivery system further comprises a linker and/or a branching unit which connects the PEG polymer to the first generation dendron, and/or forms a part of the first generation, and/or connects between dendron generations. In one embodiment, the linker moiety and/or the branching unit is selected from a group consisting of a substituted or unsubstituted acyclic, cyclic or aromatic hydrocarbon moiety, heterocyclic moiety, a heteroaromatic moiety or any combination thereof. Each possibility represents as separate embodiment of the present invention. Specific examples of linker moieties/branching units useful for this invention include but are not limited to, arylenes, which may be substituted with one or more hydroxyls (e.g., phenols), trimethylolpropane, glycerine, pentaerythritol, polyhydroxy phenols such as phloroglucinol, propylene glycol, tri-substituted alkylamines, diethylenetriamine, triethylenetetramine, diethanolamine, triethanolamine, amino carboxylic acids, such as ethylenediaminetetraacetic (EDTA) and porphyrin, ethylene glycol, ethylenediamine di-substituted alkylamines, diethylenetriamine, triethylenetetramine, diethanolamine, fumaric, maleic, phthalic, malic acid, 6-aminohexanol, 6-mercaptohexanol, 10-hydroxydecanoic acid, 1,6-hexanediol, beta-alanine, 2-aminoethanol, 2-aminoethanethiol, 5-aminopentanoic acid, and 6-aminohexanoic acid among others. Each possibility represents as separate embodiment of the present invention. In one currently preferred embodiment, the linker moiety/branching unit is an unsubstituted or substituted arylene or phenols which may be positioned between the PEG and the first generation or may form a part of the first generation, or alternatively may be positioned at one or more intermediary generations of the dendron. The linker/branching unit may further provide additional functionality to the hybrid delivery system (e.g., UV absorption).

According to various embodiments, each of the linker moiety/branching unit may be connected to the PEG or to other dendron generations through a functional group selected from the group consisting of —O—, —S—, —NH—, —C(═O)—, —C(═O)—O—, —OC(═O)— O—, —C(═O)—NH—, —NH—C(═O)—NH—, —NH—C(═O)—O—, —S(═O)—, —S(═O)—O—, PO(═O)—O—, —C═C—, —C≡C—, —(CH₂)ₜ— wherein t is an integer of 1-10, and any combination thereof. One representative example of a functional group linking the PEG to the dendron is —S—(CH₂)ₜ—NHC(O)—. Each possibility represents as separate embodiment of the present invention.

The hydrophilic PEG polymer is a currently preferred polymer to prepare the block co-polymer hybrid of the present invention as it is generally recognized as safe for use in food, agrochemicals, cosmetics, medicines and many other applications by the US Food and Drug Administration. PEG has beneficial physical and/or chemical properties such as water-solubility, non-toxic, odorless, lubricating, nonvolatile, and non-intrusive which are particularly suitable for agricultural utility.

There are many commercial available derivatives of PEG, all of which may be useful in the present invention, such as but not limited to methoxy PEG (mPEG), amine-terminated PEG (PEG-NH₂), acetylated PEG (PEG-Ac) carboxylated PEG (PEG-COOH), thiol-terminated PEG (PEG-SH), N-hydroxysuccinimide-activated PEG (PEG-NHS), NH₂-PEG-NH₂ or NH₂-PEG-COOH. Each possibility represents as separate embodiment of the present invention. These PEG derivatives may be subjected to further chemical modifications and substitutions.

According to some embodiments, the PEG has an average molecular weight between about 0.5 and 40 kDa. In one currently preferred embodiment, the hydrophilic PEG polymer is an mPEG. In another currently preferred embodiment, the PEG polymer has a molecular weight of about 2 kDa. In another currently preferred embodiment, the PEG polymer has a molecular weight of about 5 kDa. In yet another currently preferred embodiment, the PEG polymer has a molecular weight of about 10 kDa.

According to some embodiments, the hybrid delivery system is represented by the structure of formula (I):

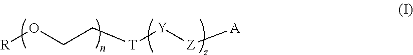

wherein
   R is H or a C1-C4 alkylene group;
   T is absent or is a functional group selected from the group consisting of —O—, —S—, —NH—, —C(═O)—, —O—C(═O)—O—, —C(═O)—O—, —C(═O)—NH—, —NH—C(═O)—NH—, —NH—C(═O)—O—, —S(═O)—, —S(═O)—O—, PO(═O)—O—, —C═C—, —C≡C—, —(CH₂)ₜ— wherein t is an integer of 1-10, and any combination thereof.
   Y is independently at each occurrence absent or is a linker moiety/branching unit;
   Z is independently at each occurrence a dendron repeating unit selected from the group consisting of:

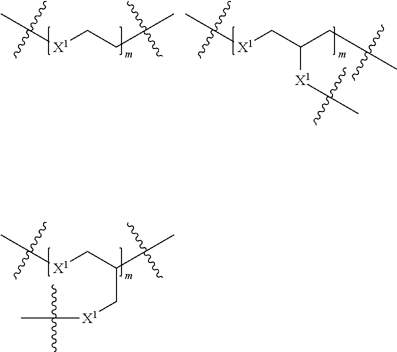

and any combination of the foregoing;
   wherein X¹ is independently, at each occurrence, selected from the group consisting of a 0, S and NH;
   A is a hydrophobic end group which is conjugated to the dendron through (i) an enzymatically cleavable functional group selected from the group consisting of an ester, an amide, a carbamate, a carbonate, a urea, a sulfate, an amidine, an ether, a phosphate, a phosphoamide, sulfamates, and a trithionate; or (ii) a pH-sensitive functional group selected from the group consisting of an ester, an amide, a urea, a sulfate, an amidine, an ether, a phosphate, a phosphoamide, sulfamates, and a trithionate or a pH-sensitive moiety selected from the group consisting of an ester, an amide, an anhydride, an imide, a carbonate, a carbamate, a thiocarbamate, a urea, sulfonylurea, an acetal, a ketal, a hemiacetal, a hemiketal, an amidine, a guanidine, a silyl ether, an imine, an enamine, a hydrazone, an oxime, a phosphate, a phosphorothionate, a phosphoroamide, a sulfonamide, and a trithionate;
   n is an integer in the range of 1 to 1,500; and
   m and z are each an integer of 1 to 15;
wherein the hydrophobic end group is or is derived from an agrochemical, or said hybrid delivery system encapsulates an agrochemical within the micelle, or a combination thereof.

In some embodiments, n is an integer in the range of 1 to 1,000.

According to some embodiments, the hydrophobic end group is or is derived from an agrochemical selected from the group consisting of a pesticide, an insecticide, a herbicide, a fungicide, an acaricide, an algicide, an antimicrobial agent, biopesticide, a biocide, a disinfectant, a fumigant, an insect growth regulator, a plant growth regulator, a miticide, a microbial pesticide, a molluscide, a nematicide, an ovicide, a pheromone, a repellent, a rodenticide, a defoliant, a dessicant, a termiticide, a piscicide, avicide, rodenticide, bactericide, insect repellent, an auxin, a cytokinin, a gametocide, a gibberellin, a growth inhibitor, and a growth stimulator.

According to other embodiments, the terminal repeating unit of said dendron is represented by any of the following structures:

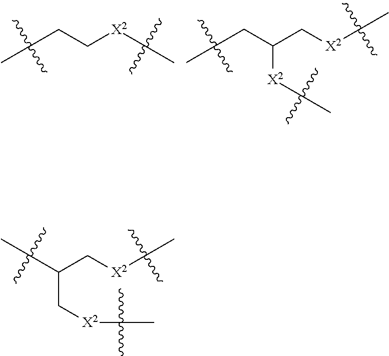

wherein X² has the same meaning as X¹.

According to yet other embodiments, the hydrophobic end group A is conjugated to the dendron through a pH-sensitive or enzymatically cleavable functional group represented by the structure:

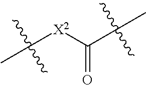

wherein X² is a part of the terminal repeating unit of said dendron and C(═O) is part of hydrophobic end group; or wherein X² is part of the hydrophobic end group and C(═O) is a part of the terminal repeating unit of said dendron or wherein X²—C(═O) are part of the hydrophobic end group, or wherein X²—C(═O) is part of the terminal repeating unit of said dendron; and wherein X² is a part of the terminal repeating unit of said dendron and has the same meaning as X¹.

Specific examples of the hybrid delivery system of formula (I) include, but are not limited to, any one or more of the following structures:

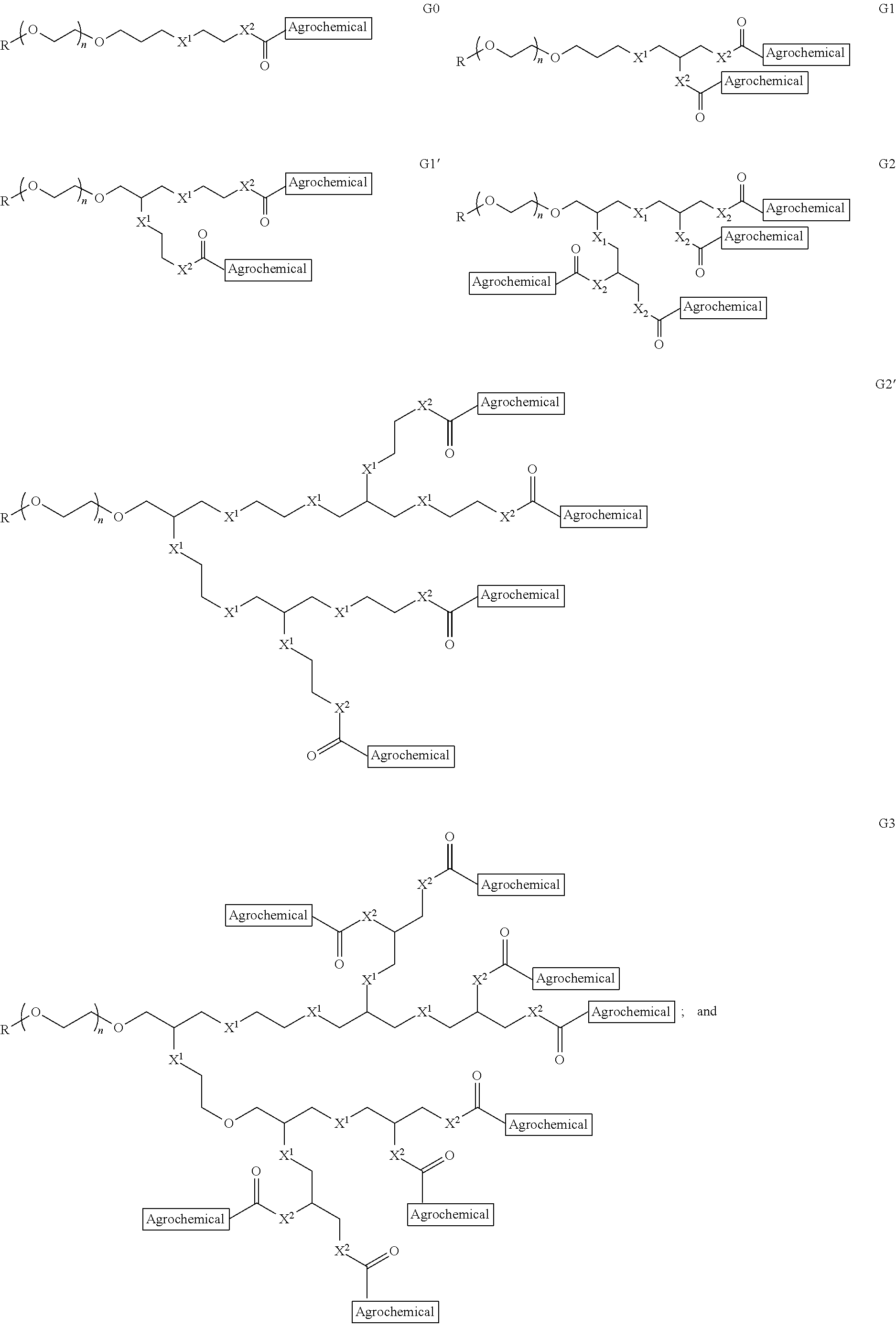

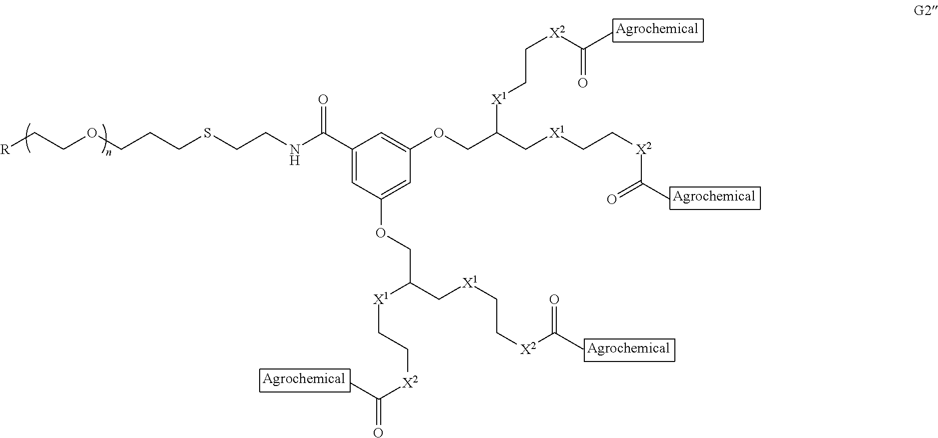

wherein each X¹ and X² is independently at each occurrence selected from the group consisting of 0, S and NH;
   R is H or an C1-C4 alkylene group; and
   n is an integer of 1 to 1,500.

In some embodiments, n is an integer in the range of 1 to 1,000.

Also contemplated are analogues of compounds of formulae G0, G1, G2, G2′, G2″ and G3 wherein the linkage of A to —X²—C(═O)— is reversed, i.e., the compounds incorporate the following moiety:

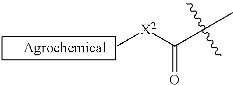

wherein X² is part of the agrochemical or part of the dendron.

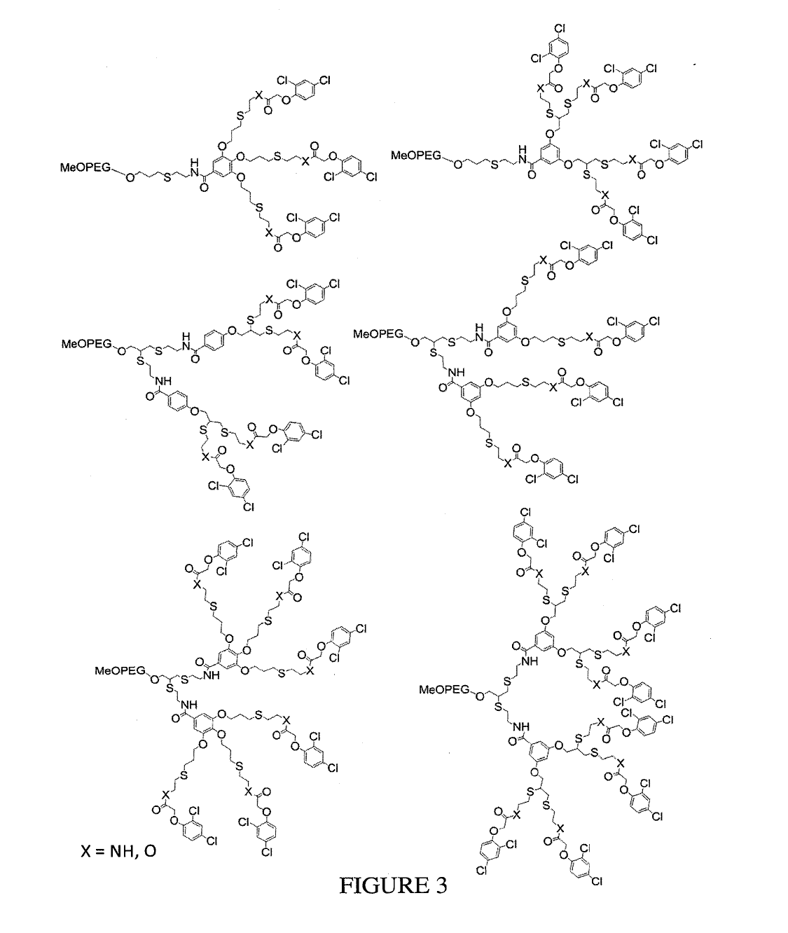

In some embodiments, the hybrid delivery system is represented by the following structures which are depicted in the experimental section below: A, B, C, D, E and F, wherein each of such structure can be based on a 2 kDa PEG, 5 kDa PEG, 10 kDa PEG, etc. Additional specific examples of the hybrid delivery system of formula (I) are those depicted in FIG. 3. It is understood by a person of skill in the art that the 2,4-dichlorophenoxyacetic acid group, i.e., the agrochemically-derived hydrophobic end group in the compounds exemplified in FIG. 3, can be replaced with any other agrochemical or agrochemical derivative as described herein. Such additional compounds are also encompassed by the present invention.

According to some embodiments, the enzymatically cleavable hydrophobic end group is conjugated to the dendron through an enzymatically cleavable functional group selected from the group consisting of an ester, an amide, a carbamate, a carbonate, a urea, a sulfate, an amidine, an ether, a phosphate, a phosphoamide, sulfamates, and a trithionate. Each possibility represents as separate embodiment of the present invention.

According to some embodiments, the enzymatically cleavable hydrophobic end group is conjugated to the dendron through an amide which is cleavable by an amidase. In one embodiment, the amidase is selected form the group of aryl-acylamidase, aminoacylase, alkylamidase, and phthalyl amidase. Each possibility represents as separate embodiment of the present invention.

According to some embodiments, the enzymatically cleavable hydrophobic end group is conjugated to the dendron through an ester which is cleavable by an esterase. In one embodiment, the esterase is selected from the group consisting of carboxylesterase, arylesterase, and acetylesterase. Each possibility represents as separate embodiment of the present invention.

According to other embodiments, the cleavable hydrophobic end group is cleaved by an enzyme which is (i) present in greater amount at; or (ii) produced in greater quantity at, or (iii) has higher activity at the delivery site of said agrochemical. Each possibility represents as separate embodiment of the present invention.

According to some embodiments, the pH-sensitive hydrophobic end group is hydrolyzed upon a change in the pH in the environment surrounding the delivery site of the system. In one embodiment, the pH-sensitive hydrophobic end group is hydrolyzed in acidic pH. In another embodiment, the cleavable moiety is hydrolyzed in neutral pH. In yet another embodiment, the pH-sensitive hydrophobic end group is hydrolyzed in basic pH. Each possibility represents as separate embodiment of the present invention.

According to some embodiments, the pH-sensitive hydrophobic end group is cleaved by acid catalyzed hydrolysis or base catalyzed hydrolysis. According to certain embodiments, the acid or base catalyzed hydrolysis may further involve the addition of metal-ion or metal-oxide.

According to other embodiments, the pH-sensitive hydrophobic end group is conjugated to the dendron through a functional group selected from the group consisting of an ester, an amide, an anhydride, an imide, a carbonate, a carbamate, a thiocarbamate, a urea, sulfonylurea, an acetal, a ketal, a hemiacetal, a hemiketal, an amidine, a guanidine, a silyl ether, an imine, an enamine, a hydrazone, an oxime, a phosphate, a phosphorothionate, a phosphoroamide, a sulfonamide, and a trithionate. Each possibility represents as separate embodiment of the present invention.

The modular design of the hybrid delivery systems of the present invention provides control over the disassembly of the micelle and release rate of the hydrophobic end groups and/or encapsulated cargo. This can be achieved by adjusting structural features of the nanocarriers (such as length of PEG polymer, dendron generation, number of pH-dependent or enzymatically cleavable hydrophobic end groups, linkage chemistry and polymer/dendron weight ratio) as well as stimuli cleavable moiety parameters (i.e., enzyme specificity, amount of enzyme, incubation time, amount of pH adjusting agent, strength of the pH agent etc.).

Hydrophobic End Groups and Encapsulated Agrochemicals

The enzymatically cleavable or pH-sensitive hydrophobic end group “A” may be an “innocent” group, i.e., it is not biologically active. Alternatively, the pH-sensitive or enzymatically cleavable hydrophobic end group may itself be, or may be derived from an agrochemically active agent. Each possibility represents a separate embodiment of the present invention.

Also, the delivery system of the present invention may further contain a second agrochemical encapsulated (non-covalently) within the micelle, wherein the agrochemical is released upon disassembly of said micelle.

According to some embodiments, the hydrophobic end group which is attached to the dendron and the compound which is encapsulated within the micelle are the same agrochemical, or they are derived from the same agrochemical. In other embodiments, the hydrophobic end group which is attached to the dendron and the agrochemicals which is encapsulated within the micelle are different compounds. One embodiment of the present invention encompasses micelles which contain hydrophobic end groups that are not in themselves active, wherein the micelle encapsulates an agrochemical and releases it upon cleavable of the hydrophobic end groups. In an alternative embodiment, the hydrophobic end group is or is derived from an agrochemical. The micelle formed therefrom releases the agrochemical upon pH-mediated or enzymatic cleavage of the hydrophobic end group. In yet another embodiment, the hydrophobic end group is or is derived from an agrochemical, and in addition the micelle encapsulates (non-covalently) a second agrochemical and releases it upon cleavage of the hydrophobic end group. The agrochemical which is part of the hydrophobic end group and which is encapsulated within the micelle may be the same or different, with each possibility representing a separate embodiment of the present invention. The term “agrochemical” is used herein includes agrochemically active agents including pesticides, insecticides etc., as further described and exemplified below.

According to some embodiments, the hydrophobic end group which is attached to the dendron and the agrochemical which is encapsulated by said micelle are each or are each derived from an agrochemical independently selected from the group consisting of acetyl CoA carboxylase inhibitors, acetolactate synthase ALS (acetohydroxyacid synthase AHAS) inhibitors, photosynthesis at photosystem II inhibitors, photosystem-I-electron diversion inhibitors, protoporphyrinogen oxidase (PPO) inhibitors, carotenoid biosynthesis at the phytoene desaturase step (PDS) inhibitors, 4-hydroxyphenyl-pyruvate-dioxygenase (4-HPPD) inhibitors, carotenoid biosynthesis inhibitors, EPSP synthase inhibitors, glutamine synthase inhibitors, DHP (dihydropteroate) synthase inhibitors, microtubule assembly inhibitors, mitosis inhibitors, cell division inhibitors, cell wall (cellulose) synthesis inhibitors, melanin synthesis in cell wall inhibitors, uncoupling disruptors, lipid synthesis inhibitors, synthetic auxins, auxin transport inhibitors, nucleic acids synthesis inhibitors, respiration inhibitors (including: mitochondrial ATP synthase inhibitors, uncouplers of oxidative phosphorylation via disruption of the proton gradient, mitochondrial complex III electron transport inhibitors, mitochondrial complex I electron transport inhibitors, mitochondrial complex IV electron transport inhibitors, and mitochondrial complex II electron transport inhibitors), amino acids and protein synthesis inhibitors, signal transduction inhibitors, sterol biosynthesis in membranes inhibitors, host plant defence induction inhibitors, acetylcholinesterase (AChE) inhibitors, GABA-gated chloride channel antagonists, sodium channel modulators, nicotinic acetylcholine receptor (nAChR) agonists, nicotinic acetylcholine receptor (nAChR) allosteric activators, chloride channel activators, juvenile hormone mimics, miscellaneous non-specific (multi-site) inhibitors, modulators of chordotonal organs, mite growth inhibitors, microbial disruptors of insect midgut membranes, nicotinic acetylcholine receptor (nAChR) channel blockers, chitin biosynthesis type 0 and 1 inhibitors, moulting dipteran disruptor, ecdysone receptor agonists, octopamine receptor agonists, voltage-dependent sodium channel blockers, ryanodine receptor modulators and any combination thereof.

Non limiting examples of acetyl CoA carboxylase inhibitors include clodinafop-propargyl, cyhalofop-butyl, diclofop-methyl, fenoxaprop-P-ethyl, fluazifop-P-butyl, haloxyfop-R-methyl, propaquizafop, quizalofop-P-ethyl, alloxydim, butroxydim, clethodim, cycloxydim, profoxydim, sethoxydim, tepraloxydin, tralkoxydim, pinoxaden among others. Each possibility represents as separate embodiment of the present invention.

Non limiting examples of acetolactate synthase ALS (acetohydroxy acid synthase AHAS) inhibitors include amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl-sodium, foramsulfuron, halosulfuron-methyl, imazosulfuron, iodosulfuron, mesosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, trifloxysulfuron, triflusulfuron-methyl, tritosulfuron, imazapic, imazamethabenz-methyl, imazamox, imazapyr, imazaquin, imazethapyr, cloransulam-methyl, diclosulam, florasulam, flumetsulam, metosulam, penoxsulam, bispyribac-Na, pyribenzoxim, pyriftalid, pyrithiobac-Na, pyriminobac-methyl, flucarbazone-Na, and propoxycarbazone-Na among others. Each possibility represents as separate embodiment of the present invention.

Non limiting examples of photosynthesis at photosystem II inhibitors include ametryne, atrazine, cyanazine, desmetryne, dimethametryne, prometon, prometryne, propazine, simazine, simetryne, terbumeton, terbuthylazine, terbutryne, trietazine, hexazinone, metamitron, metribuzin, amicarbazone, bromacil, lenacil, terbacil, pyrazon (chloridazon), desmedipham, phenmedipham, chlorobromuron, chlorotoluron, chloroxuron, dimefuron, diuron, ethidimuron, fenuron, fluometuron, isoproturon, isouron, linuron, methabenzthiazuron, metobromuron, metoxuron, monolinuron, neburon, siduron, tebuthiuron, propanil, pentanochlor, bromofenoxim, bromoxynil, ioxynil, bentazon, pyridate, and pyridafol among others. Each possibility represents as separate embodiment of the present invention.

Non limiting examples of Photosystem-I-electron diversion inhibitors include diquat and paraquat among others. Each possibility represents as separate embodiment of the present invention.

Non limiting examples of protoporphyrinogen oxidase (PPO) inhibitors include acifluorfen-na, bifenox, chlomethoxyfen, fluoroglycofen-ethyl, fomesafen, halosafen, lactofen, oxyfluorfen, fluazolate, pyraflufen-ethyl, cinidon-ethyl, flumioxazin, flumiclorac-pentyl, fluthiacet-methyl, thidiazimin, oxadiazon, oxadiargyl, azafenidin, carfentrazone-ethyl, sulfentrazone, pentoxazone, benzfendizone, butafenacil, pyraclonil, profluazol, and flufenpyr-ethyl among others. Each possibility represents as separate embodiment of the present invention.

Non limiting examples of carotenoid biosynthesis at the phytoene desaturase step (PDS) inhibitors include norflurazon, diflufenican, picolinafen, beflubutamid, fluridone, flurochloridone, and flurtamone among others. Each possibility represents as separate embodiment of the present invention.

Non limiting examples of 4-hydroxyphenyl-pyruvate-dioxygenase (4-HPPD) inhibitors include mesotrione, sulcotrione, isoxachlortole, isoxaflutole, benzofenap, pyrazolynate, pyrazoxyfen, and benzobicyclon among others. Each possibility represents as separate embodiment of the present invention.

Non limiting examples of carotenoid biosynthesis inhibitors (unknown target) include amitrole, clomazone, fluometuron, and aclonifen among others. Each possibility represents as separate embodiment of the present invention.

Non limiting examples of EPSP synthase inhibitors include glyphosate and sulfosate among others. Each possibility represents as separate embodiment of the present invention.

Non limiting examples of glutamine synthase inhibitors include glufosinate-ammonium and bialaphos (bilanaphos) among others. Each possibility represents as separate embodiment of the present invention.

DHP (dihydropteroate) synthase inhibitors includes, for example, asulam and the like.

Non limiting examples of microtubule assembly inhibitors include benefin (benfluralin), butralin, dinitramine, ethalfluralin, oryzalin, pendimethalin, trifluralin, amiprophos-methyl, butamiphos, dithiopyr, thiazopyr, propyzamide (pronamide), tebutam, and DCPA (chlorthal-dimethyl) among others. Each possibility represents as separate embodiment of the present invention.

Non limiting examples of mitosis and cell division inhibitors chlorpropham, propham, carbetamide, acetochlor, alachlor, butachlor, dimethachlor, dimethanamid, etazachlor, metolachlor, pethoxamid, pretilachlor, propachlor, propisochlor, thenylchlor, diphenamid, napropamide, naproanilide, flufenacet, mefenacet, fentrazamide, anilofos, cafenstrole, piperophos, benomyl, carbendazim, fuberidazole, thiabendazole, thiophanate, thiophanate-methyl, diethofencarb, zoxamide, ethaboxam, pencycuron, and fluopicolide among others. Each possibility represents as separate embodiment of the present invention.

Non limiting examples of cell wall (cellulose) synthesis inhibitors include dichlobenil, chlorthiamid, isoxaben, flupoxam, quinclorac polyoxin, dimethomorph, flumorph, pyrimorph, mandipropamid and fthalide among others. Each possibility represents as separate embodiment of the present invention.

Non limiting examples of melanin synthesis in cell wall inhibitors include pyroquilon, tricyclazole, carpropamid, diclocymet, fenoxanil, and acibenzolar-S-methyl among others. Each possibility represents as separate embodiment of the present invention.

Non limiting examples of uncoupling disruptors include DNOC, dinoseb, and dinoterb among others. Each possibility represents as separate embodiment of the present invention.

Non limiting examples of lipid synthesis inhibitors include butylate, cycloate, dimepiperate, EPTC, esprocarb, molinate, orbencarb, pebulate, prosulfocarb, thiobencarb (benthiocarb), tiocarbazil, triallate, vernolate, bensulide, benfuresate, ethofumesate, TCA, dalapon, and flupropanate among others. Each possibility represents as separate embodiment of the present invention.

Non limiting examples of synthetic auxins include clomeprop, 2,4-D, 2,4-DB, dichlorprop (2,4-DP), MCPA, MCPB, mecoprop (MCPP or CMPP), chloramben, dicamba, TBA, clopyralid, fluroxypyr, picloram, triclopyr, quinclorac, and benazolin-ethyl among others. Each possibility represents as separate embodiment of the present invention.

Non limiting examples of auxin transport inhibitors include naptalam and diflufenzopyr-Na among others. Each possibility represents as separate embodiment of the present invention.

Non limiting examples of nucleic acids synthesis inhibitors include benalaxyl, benalaxyl-M, furalaxyl, metalaxyl, metalaxyl-M, oxadixyl, ofurace, bupirimate, dimethirimol, ethirimol, hymexazole, and octhilinone among others. Each possibility represents as separate embodiment of the present invention.

Non limiting examples of respiration inhibitors (including: mitochondrial ATP synthase inhibitors, uncouplers of oxidative phosphorylation via disruption of the proton gradient, mitochondrial complex III electron transport inhibitors, mitochondrial complex I electron transport inhibitors, mitochondrial complex IV electron transport inhibitors, and mitochondrial complex II electron transport inhibitors) include diflumetorim, tolfenpyrad, benodanil, flutolanil, mepronil, sofetamid, fluopyram, fenfuram, carboxin, oxycarboxin, thifluzamide, benzovindiflupyr, bixafen, fluxapyroxad, furametpyr, isopyrazam, penflufen, penthiopyrad, sedaxane, boscalid, mandestrobin, pyraclostrobin, pyrametostrobin, triclopyricarb, kresoxim-methyl, trifloxystrobin, dimoxystrobin, fenaminstrobin, metominostrobin, orysastrobin, famoxadone, fluoxastrobin, fenamidone, pyribencarb, cyazofamid, amisulbrom, binapacryl, meptyldinocap, dinocap, fluazinam, ferimzone, fentin acetate, fentin chloride, fentin hydroxide, silthiofam, ametoctradin, cyprodinil, mepanipyrim, pyrimethanil, diafenthiuron, azocyclotin, cyhexatin, fenbutatin oxide, propargite, tetradifon, chlorfenapyr, DNOC, sulfluramid hydramethylnon, acequinocyl, fluacrypyrim, fenazaquin, fenpyroximate, pyrimidifen, pyridaben, tebufenpyrad, tolfenpyrad, rotenone (derris), aluminium phosphide, calcium phosphide, phosphine, zinc phosphide, cyanide, cyenopyrafen, and cyflumetofen among others. Each possibility represents as separate embodiment of the present invention.

Non limiting examples of amino acids and protein synthesis inhibitors include blasticidin-S, kasugamycin, streptomycin, oxytetracycline, and quinoxyfen among others. Each possibility represents as separate embodiment of the present invention.

Non limiting examples of signal transduction inhibitors include proquinazid, fenpiclonil, fludioxonil, chlozolinate, iprodione, procymidone, vinclozolin, edifenphos, iprobenfos (IBP), and pyrazophos among others. Each possibility represents as separate embodiment of the present invention.

Non limiting examples of sterol biosynthesis in membranes inhibitors include isoprothiolane, biphenyl, chloroneb, dicloran, quintozene (PCNB), tecnazene (TCNB), tolclofos-methy, etridiazole, odocarb, propamocarb, prothiocarb, bacillus subtilis syn. B. amyloliquefaciens strain QST 713, bacillus amyloliquefaciens strain FZB24, bacillus amyloliquefaciens strain MBI600, bacillus amyloliquefaciens strain D747, and extract from Melaleuca alternifolia among others. Each possibility represents as separate embodiment of the present invention.

Non limiting examples of host plant defence induction inhibitors include probenazole, tiadinil, isotianil, laminarin, and extract from Reynoutria sachalinensis (giant knotweed) among others. Each possibility represents as separate embodiment of the present invention.

Non limiting examples of acetylcholinesterase (AChE) inhibitors include alanycarb, aldicarb, bendiocarb, benfuracarb, butocarboxim, butoxycarboxim, carbaryl, arbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC, xylylcarb, acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl 0-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, and vamidothion among others. Each possibility represents as separate embodiment of the present invention.

Non limiting examples of GABA-gated chloride channel antagonists include chlordane, endosulfan, ethiprole, and fipronil among others. Each possibility represents as separate embodiment of the present invention.

Non limiting examples of sodium channel modulators include acrinathrin, allethrin, d-cis-trans allethrin, d-trans allethrin, bifenthrin, bioallethrin, bioallethrin scyclopentenyl isomer, bioresmethrin, cycloprothrin, cyfluthrin, β-cyfluthrin, cyhalothrin, λ-cyhalothrin, γ-cyhalothrin, cypermethrin, α-cypermethrin, β-cypermethrin, θ-cypermethrin, ζ-cypermethrin, cyphenothrin, deltamethrin, empenthrin (EZ)-(1R)-isomers, esfenvalerate, etofenprox, fenpropathrin, fenvalerate, flucythrinate, flumethrin, τ-fluvalinate, halfenprox, imiprothrin, kadethrin, permethrin, phenothrin [(1R)-trans-isomer], prallethrin, pyrethrins (pyrethrum), resmethrin, silafluofen, tefluthrin, tetramethrin, tetramethrin [(1R)-isomers], tralomethrin, transfluthrin, DDT, and methoxychlor among others. Each possibility represents as separate embodiment of the present invention.

Non limiting examples of nicotinic acetylcholine receptor (nAChR) agonists include acetamiprid, clothianidin, dinotefuran, imidacloprid, nitenpyram, thiacloprid, thiamethoxam, nicotine, sulfoxaflor, and flupyradifurone among others. Each possibility represents as separate embodiment of the present invention.

Non limiting examples of nicotinic acetylcholine receptor (nAChR) allosteric activators include spinetoram, and spinosad among others. Each possibility represents as separate embodiment of the present invention.

Non limiting examples of chloride channel activators include abamectin, emamectin benzoate, lepimectin, and milbemectin among others. Each possibility represents as separate embodiment of the present invention.

Non limiting examples of juvenile hormone mimics include hydroprene, kinoprene, methoprene, fenoxycarb, and pyriproxyfen among others. Each possibility represents as separate embodiment of the present invention.

Non limiting examples of modulators of chordotonal organs include methyl bromide and other alkyl halides, chloropicrin, sulfuryl fluoride, borax, and tartar emetic among others. Each possibility represents as separate embodiment of the present invention.

Mite growth inhibitors include for example, pymetrozine, and flonicamid among others. Each possibility represents as separate embodiment of the present invention.

Non limiting examples of microbial disruptors of insect midgut membranes include clofentezine, hexythiazox, diflovidazin and etoxazole among others. Each possibility represents as separate embodiment of the present invention.

Non limiting examples of nicotinic acetylcholine receptor (nAChR) channel blockers include Bacillus thuringiensis subsp. israelensis, Bacillus thuringiensis subsp. aizawai, Bacillus thuringiensis subsp. kurstaki, Bacillus thuringiensis subsp. tenebrionis, and B.t. crop proteins: Cry1Ab, Cry1Ac, Cry1Fa, Cry1A.105, Cry2Ab, Vip3A, mCry3A, Cry3Ab, Cry3Bb, Cry34Ab1/Cry35Ab1 among others. Each possibility represents as separate embodiment of the present invention.

Non limiting examples of chitin biosynthesis type 0 and 1 inhibitors include bistrifluron, chlorfluazuron, diflubenzuron, flucycloxuron, flufenoxuron, hexaflumuron, lufenuron, novaluron, noviflumuron, teflubenzuron, triflumuron, and buprofezin among others. Each possibility represents as separate embodiment of the present invention.

Moulting dipteran disruptor include, for example, cyromazine and the like.

Non limiting examples of ecdysone receptor agonists include chromafenozide, halofenozide, methoxyfenozide, and tebufenozide among others. Each possibility represents as separate embodiment of the present invention.

Octopamine receptor agonists include, for example, amitraz and the like.

Non limiting examples of voltage-dependent sodium channel blockers include indoxacarb and metaflumizone among others. Each possibility represents as separate embodiment of the present invention.

Non limiting examples of ryanodine receptor modulators include chlorantraniliprole, cyantraniliprole, and flubendiamide among others. Each possibility represents as separate embodiment of the present invention.

Non limiting examples of additional pesticides that are useful in the present invention include flamprop-M-methyl/-isopropyl, difenzoquat, DSMA, MSMA, bromobutide, (chloro)-flurenol, cinmethylin, cumyluron, dazomet, dymron (daimuron), methyl-dimuron (methyl-dymron), etobenzanid, fosamine, indanofan, metam, oxaziclomefone, oleic acid, pelargonic acid, pyributicarb, triazoxide, flusulfamide, diclomezine, methasulfocarb, cyflufenamid, metrafenone, pyriofenone, dodine, flutianil, ferimzone, oxathiapiprolin, tebufloquin, mineral oils, organic oils, potassium bicarbonate, material of biological origin, copper (different salts), sulphur, ferbam, mancozeb, maneb, metiram, propineb, thiram, zineb, ziram, captan, captafol, folpet, chlorothalonil, dichlofluanid, tolylfluanid, guazatine, iminoctadine, anilazine, dithianon, chinomethionat, quinomethionate, fluoroimide, azadirachtin, benzoximate, bifenazate, bromopropylate, chinomethionat, cryolite, dicofol, pyridalyl, pyrifluquinazon, chlorothalanil, chlorsulfuron cyanazine, copper hydroxide, copper sulfate, cypermithrin, diazinon, diclofop methyl, dimethenamid, endothall, ethephon, matolachlor-S, sethoxydin, and triforine among others. Each possibility represents as separate embodiment of the present invention.

The term “pesticide” as used herein refers to a chemical used for plant, crop or livestock protection against unwanted organisms (“pests”). Pesticides include insecticides, herbicides, fungicides, acaricides, algicides, antimicrobial agents, biopesticides, biocides, disinfectants, fumigants, insect growth regulators, plant growth regulators, miticides, microbial pesticides, molluscides, nematicides, ovicides, pheromones, repellents, rodenticides, defoliants, dessicants, a termiticide, a piscicide, avicide, rodenticide, bactericide, insect repellent, an auxin, a cytokinin, a gametocide, a gibberellin, a growth inhibitor, a growth stimulator and any combination thereof. Each possibility represents as separate embodiment of the present invention. Pests include invertebrates such as insects, mites, slugs, snails, nematodes, flatworms, millipedes, pathogenic protozoa, weeds, fungi, moulds, bryophites, lichens, algae, yeasts, bacteria and viruses, as well as vertebrates such as rodents, rabbits and pigeons. Pesticides further include, but are not limited to organophosphate pesticides, carbamate pesticides, organochlorine insecticides and pyrethroid pesticides. Other examples of pesticides are disclosed in sources such as Recognition and Management of Pesticide Poisonings (US Environmental Protection Agency), the contents of which are incorporated by reference herein.

Insecticides kill insects and other arthropods. Herbicides kill weeds and other vegetation that grows in unwanted locations. Fungicides kill fungi, including blights, mildews, molds, and rusts. Acarcides (also called miticides) kill mites in plants. Algicides control algae in lakes, canals, swimming pools, water tanks, and other sites. Antimicrobial agents kill microorganisms including bacteria viruses, parasites and protozoa. Biopesticides are specific types of pesticides derived from such natural materials as plants, bacteria, and certain minerals. Biocides kill microorganisms. Disinfectants kill or inactivate disease-producing microorganisms on inanimate objects. Fumigants produce gas or vapor intended to destroy pests in buildings or soil. Insect growth regulators disrupt the molting, maturity from pupal stage to adult or other life processes of insects. Plant growth regulators are substances (excluding fertilizers or other plant nutrients) that alter the expected growth, flowering, or reproduction rate of plants. Microbial pesticides are microorganisms that kill, inhibit, or out-compete pests, including insects or other microorganisms. Molluscicides kill snails and slugs. Nematicides kill nematodes (microscopic, worm-like organisms that feed on plant roots). Ovicides kill eggs of insects and mites. Pheromones are biochemicals used to disrupt the mating behavior of insects. Repellants repel pests, including insects (such as mosquitoes) and birds. Rodenticides control mice and other rodents. Defoliants cause leaves or other foliage to drop from a plant, usually to facilitate harvest. Dessicants promote drying of living tissues, such as unwanted plant tops. Biopesticides include: (1) microbial pesticides; (2) Plant-Incorporated-Protectants (PIPs), and (3) biochemical pesticides. Microbial pesticides can control many different kinds of pests, although each separate active ingredient is relatively specific for its target pest[s]. For example, there are fungi that control certain weeds, and other fungi that kill specific insects. The most widely used microbial pesticides are subspecies and strains of Bacillus thuringiensis, or Bt. Each strain of this bacterium produces a different mix of proteins, and specifically kills one or a few related species of insect larvae. While some Bt's control moth larvae found on plants, other Bt's are specific for larvae of flies and mosquitoes. The target insect species are determined by whether the particular Bt produces a protein that can bind to a larval gut receptor, thereby causing the insect larvae to starve. PIPs are pesticidal substances that plants produce from genetic material that has been added to the plant. For example, plants transformed with the gene encoding the Bt pesticidal protein. Biochemical pesticides are naturally occurring substances that control pests by non-toxic mechanisms, for example, insect sex pheromones, which interfere with mating, as well as various scented plant extracts that attract insect pests to traps. Termiticides kill termites. piscicides poisonous to fish and is used to combat parasitic and invasive species of fish. Avicides kill birds. Rodenticide is a poison used to kill rodents. bactericides are used for plant bacterial disease control. Insect repellents (also called pest-repelling plants) are known for their ability to repel insects, nematodes, and other pests. Auxins are a class of plant hormones (or plant growth substances) which coordinate many growth and behavioral processes in the plant's life cycle, they are essential for plant body development. Cytokinins are a class of plant hormones involved primarily in cell growth and differentiation. Defoliant are sprayed or dusted on plants to cause the leaves to fall off. Gametocides kill gametes or gametocytes. Gibberellins are plant hormones that regulate growth and influence various developmental processes, including stem elongation, germination, dormancy, flowering, sex expression, enzyme induction, and leaf and fruit senescence. Growth inhibitors are regulating substances which retard such processes as root and steam elongation, seed germination and bud opening. These inhibitors are used to keep plants at a desired size and shape and control fruit formation. Growth stimulator promote growth rate, improve plant's disease resistance, maintain quality and improve the flowering and fruiting yields.

In another embodiment, the insecticide is selected from the group consisting of benzoyl ureas such as novaluron, lufenuron, chlorfluazuron, flufenoxuron, hexaflumuron, noviflumuron, teflubenzuron, triflumuron and diflubenzuron; carbamates; pyrethroids such as cyhalothrin and isomers and isomer mixtures thereof, lambda-cyhalothrin, deltamethrin, tau-fluvalinate, cyfluthrin, beta-cyfluthrin, tefluthrin, and, bifenthrin; organophosphates such as azinfos-methyl, chlorpyrifos, diazinon, endosulfan, methidathion; neonicotinoids, and phenylpyrazoles such as imidacloprid, acetamiprid, thiacloprid, dinotefuran, thiamethoxam and fipronil;

In another embodiment, the fungicidally active compound is selected from the group consisting of 2-phenylphenol, 8-hydroxyquinoline sulfate, AC 382042, ampelomyces quisqualis, acibenzolar, acypetacs, aldimorph, allyl alcohol, ametoctradin, amisulbrom, ampropylfos, anilazine, aureofungin, azaconazole, azoxystrobin, azithiram, azoxystrobin, bacillus subtilis, barium polysulfide, benalaxyl, benalaxyl-M, benodanil, benomyl, benquinox, bentaluron, benthiavalicarb, benzalkonium chloride, benzamacril, benzamorf, benzohydroxamic acid, bethoxazin, binapacryl, biphenyl, bitertanol, bithionol, bixafen, blasticidin-S, borax, bordeaux mixture, boscalid, bromuconazole, bupirimate, burgundy mixture, buthiobate, butylamine, calboxin, calcium polysulfide, captafol, captan, carbamorph, carbendazim, carboxin, carpropamid (KTU 3616), carvone, cheshunt mixture, CGA 279202, chinomethionat, chlobenthiazone, chloraniformethan, chloranil, chlorfenazole, chlorodinitronaphthalene, chloroneb, chloropicrin, chlorothalonil, chlorquinox, chlozolinate, climbazole, clotrimazole, copper acetate, copper carbonate—basic, copper hydroxide, copper naphthenate, copper oleate, copper oxychloride, copper silicate, copper sulfate, copper sulfate—basic, copper zinc chromate, cresol, cufraneb, cuprobam, cuprous oxide, cyazofamid, cyclafuramid, cycloheximide, cyflufenamid, cymoxanil, cypendazole, cyproconazole, cyprodinil, dazomet, DBCP, debacarb, decafentin, dehydroacetic acid, dichlofluanid, dichlone, dichlorophen, dichlozoline, diclobutrazol, diclocymet, dichlomezine, dicloran, dichlorophen, diclocymet, diethofencarb, diethyl pyrocarbonate, difenoconazole, difenzoquat, difenzoquat metilsulfate, diflumetorim, dimethirimol, dimethomorph, dimoxystrobin, diniconazole, diniconazole-M, dinobuton, dinocap, dinocap-4, dinocap-6, dinocton, dinopenton, dinosulfon, dinoterbon, diphnenylamine, dipyrithione, disulfiram, ditalimfos, ditalimfos, dithianon, DNOC, dodemorph, dodemorph acetate, dodine, dodine free base, drazoxolon, edifenphos, epoxiconazole (BAS 480F), etaconazole, etem, ethaboxam, ethasulfocarb, ethirimol, ethoxyquin, ethylmercury 2,3-dihydroxypropyl mercaptide, ethylmercury acetate, ethylmercury bromide, ethylmercury chloride, ethylmercury phosphate, (3-ethoxypropyl)mercury bromide, etridiazole, famoxadone, fenamidone, fenaminosulf, fenapanil, fenarimol, fenbuconazole, fenfin, fenfuram, fenhexamid, fenitropan, fenoxanil, fenpiclonil, fenpropidin, fenpropimorph, fentin, fentin acetate, fentin hydroxide, ferbam, ferimzone, fluazinam, fludioxonil, flumetover, flumorph, fluopicolide, fluopyram, fluoroimide, fluotrimazole, fluoxastrobin, fluquinconazole, flusilazole, flusulfamide, flutianil, flutolanil, flutriafol, folpet, formaldehyde, fosetyl, fosetyl-aluminum, fuberidazole, furalaxyl, furametpyr, furcarbanil, furconazole, furconazole-cis, furfural, furmecyclox, furophanate, fusarium oxysporum, gliocladium virens, glyodin, griseofulvin, guazatine, guazatine acetates, GY-81, halacrinate, hexachlorobenzene, hexachlorobutadiene, hexaconazole, hexylthiofos, hydrargaphen, 8-hydroxyquinoline sulfate, hymexazol, ICIA0858, IKF-916, imazalil, imazalil sulfate, imibenconazole, iminoctadine, iminoctadine triacetate, iminoctadine tris(albesilate), iodomethane, ipconazole, iprobenfos, iprodione, iprovalicarb, isoprothiolane, isopyrazam, isotianil, isovaledione, kasugamycin, kasugamycin hydrochloride hydrate, kresoxim-methyl, mancopper, mancozeb, mandipropamid, maneb, mebenil, mecarbinzid, mepanipyrim, mepronil, meptyldinocap, mercuric chloride, mercuric oxide, mercurous chloride, metalaxyl, metalaxyl-M, metam, metam-sodium, metazoxolon, metconazole, methasulfocarb, methfuroxam, 2-methoxyethylmercury chloride, methyl bromide, methyl isothiocyanate, methylmercury benzoate, methylmercury dicyandiamide, methylmercury pentachlorophenoxide, metiram, metominostrobin (SSF-126), metrafenone, metsulfovax, milneb, MON65500, myclotbutanil, myclobutanil, myclozolin, N-(ethylmercury)-p-toluenesulphonanilide, nabam, naphthenic acid, natamycin, nickel (dimethyldithiocarbamate), nitrostyrene, nitrothal-isopropyl, nuarimol, OCH, octhilinone, ofurace, oleic acid (fatty acids), orysastrobin, oxadixyl, oxine-copper, oxpoconazole, oxycarboxin, pefurazoate, penconazole, pencycuron, penflufen, pentachlorophenol, pentachlorophenyl laurate, penthiopyrad, perfurazoate, 8-phenyl-mercurioxyquinoline, phenylmercuriurea, phenylmercury acetate, phenylmercury chloride, phenylmercury derivative of pyrocatechol, phenylmercury nitrate, phenylmercury salicylate, 2-phenylphenol, phlebiopsis gigantea, phosdiphen, phthalide, picoxystrobin, piperalin, polycarbamate, polyoxin B, polyoxins, polyoxorim, potassium azide, potassium hydroxyquinoline sulfate, potassium polysulfide, potassium thiocyanate, probenazole, prochloraz, procymidone, propamocarb, propamocarb hydrochloride, propiconazole, propineb, proquinazid, prothiocarb, prothioconazole, pyracarbolid, pyraclostrobin, pyrametostrobin, pyraoxystrobin, pyrazophos, pyribencarb, pyributicarb, pyridinitril, pyrifenox, pyrimethanil, pyroquilon, pyroxychlor, pyroxyfur, quinacetol, quinazamid, quinconazole, quinoxyfen, quint ozene, rabenzazole, RH-7281, salicylanilide; sec-butyl amine, sedaxane, silthiofam, simeconazole, sodium azide, sodium ortho-phenylphenoxide, sodium pentachlorophenoxide, sodium 2-phenylphenoxide, sodium pentachlorophenoxide, sodium polysulfide, spiroxamine (KWG 4168), Streptomyces griseoviridis, streptomycin, sulfur, sultropen, tar oils, TCMTB, tebuconazole, tebufloquin, tecloftalam, tecnazene, tecoram, tetraconazole, thiabendazole, thiadifluor, thicyofen, thifluzamide, thiochlorfenphim, thiomersal, thiophanate, thiophanate-methyl, thioquinox, thiram, tiadinil, tioxymid, tolclofos-methyl, tolylfluanid, tolylmercury acetate, triadimefon, triadimenol, triamiphos, triarimol, triazbutil, triazoxide, tributyltin oxide, trichlamide, trichoderma harzianum, tricyclazole, tridemorph, trifloxystrobin, triflumizole, triforine, triticonzole, uniconazole, uniconazole-P, validamycin, valifenalate, vinclozolin, zarilamid, zinc naphthenate, zineb, ziram, zoxamide, and the compounds having the chemical name methyl (E,E)-2-(2-(1-(1-(2-pyridyl) propyloxyimino)-1-cyclopropylmethyloxy-methyl)phenyl)-3-ethoxypropenoate, and 3-(3,5-dichlorophenyl)-4-chloropyrazole among others. Each possibility represents as separate embodiment of the present invention.

In another embodiment, the herbicide is selected from the group consisting of 2,3,6-TBA, 2,4-D, 2,4-D-2-ethylhexyl, 2,4-DB, 2,4-DB-butyl, 2,4-DB-dimethylammonium, 2,4-DB-isooctyl, 2,4-DB-potassium, 2,4-DB-sodium, 2,4-D-butotyl (2,4-D-Butotyl (2,4-D Butoxyethyl Ester)), 2, 4-D-butyl, 2,4-D-dimethylammonium, 2,4-D-diolamine, 2,4-D-isoctyl, 2,4-D-isopropyl, 2,4-D-sodium, 2,4-D-trolamine, acetochlor, acifluorfen, aclonifen, acifluorf en-sodium, acrolein, AKH-7088, alachlor, allidochlor, alloxydim, alloxydim-sodium, allyl alcohol, alorac, ametridione, ametryn, amibuzin, amicarbazone, amidosulfuron, aminocyclopyrachlor, aminopyralid, aminopyralid, amiprofos-methyl, amitrole, ammonium sulfamate, anilofos, anisuron, asulam, asulam-sodium, atraton, atrazine, azafenidin, azimsulfuron, azimsulfuron, aziprotryne, barban, BCPC, beflubutamid, benazolin, benazolin-ethyl, bencarbazone, bencarbazone, benfluralin, benfuresate, benoxacor, bensulfuron, bensulfuron-methyl, bensulide, bentazone, bentazone-sodium, benofenap, benzadox, benzfendizone, benzipram, benzobicyclon, benzofenap, benzofluor, benzoylprop, benzthiazuron, benzthiazuron, bicyclopyrone, bifenox, bilanofos, bilanafos-sodium, bispyribac, bispyribac-sodium, borax, bromacil, bromobonil, bromobutide, brompyrazon, bromofenoxim, bromoxynil, bromoxynil-heptanoate, bromoxynil-octanoate, bromoxynil-potassium, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbasulam, carbetamide, carboxazole, carboxazole, carfentrazone, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlorimuron-ethyl, chloroacetic acid, chlornitrofen, chloropon, chlorotoluron, chloroxuron, chloroxynil, chlorprocarb, chlorpropham, chlorsulfuron, chlorthal, chlorthal-dimethyl, chlorthiamid, cinidon-ethyl, cinmethylin, cinosulfuron, cisanilide, clethodim, cliodinate, clodinafop, clofop, clodinafoppropargyl, clomazone, clomeprop, clomeprop, cloprop, cloproxydim, clopyralid, clopyralidolamine, cloquintocet, cloquintocet-methyl, cloransulam, chloransulam-methyl, CMA, copper sulfate, CPA, CPA-dimethylammonium, CPA-isoctyl, CPA-thioethyl, 4-CPA, 4-CPB, CPMF, 4-CPP, CPPC, credazine, cresol, cumyluron, cyanamide, cyanatryn, cyanazine, cycloate, cyclosulfamuron, cycloxydim, cycluron, cyhalofop, cyhalofop-butyl, cyperquat, cyprazine, cyprazole, cypromid, 2,4-D, 3,4-DA, daimuron, dalapon, dalapon-sodium, dazomet, desmeduipham, 2,4-DB, 3,4-DB, 2,4-DEB, delachlor, 2,4-DEP, desmedipham, desmetryn, di-allate, dicamba, dicambadimethylammonium, dicamba-potassium, dicambasodium, dicambatrolamine, dichlobenil, dichloralurea, dichlormid, dichlormate, dichlorprop, dichlorprop-butotyl (dichlorprop-butotyl) dichlorpropbutoxyethyl ester)), dichlorpropdimethylammonium, dichlorprop-isoctyl, dichlorprop-P, dichlorprop-potassium, diclofop, diclofop-methyl, diclosulam, diclosulam, diethamquat, diethatyl, difenopenten, difenoxuron, difenzoquat, difenzoquat metilsulfate, diflufenican, diflufenican, diflufenzopyr (BAS 65400H), dimefuron, dimepiperate, dimeth-achlor, dimethametryn, dimethenamid, dimethenamid-P, dimethipin, dimethylarsinic acid, dimexano, dimidazon, dinitramine, dinofenate, dinoprop, dinosam, dinoseb, dinoterb, dinoterbacetate, dinoterb-ammonium, dinoterb-diolamine, diphenamid, dipropetryn, diquat, diquat dibromide, disul, dithiopyr, diuron, DMPA, DNOC, 3,4-DP, DSMA, EBEP, eglinazine, endothal, epronaz, epronaz, EPTC, erbon, esprocarb, ethalfluralin, ethametsulfuron, ethametsulfuron-methyl, ethidimuron, ethiolate, ethofumesate, ethoxyfen, ethoxysulfuron, etinofen, etnipromid, etnipromid, etnipromid, etobenzanid, EXD, fenasulam, fenasulam, fenasulam, fenchlorazole-ethyl, fenclorim, fenoprop, fenoxaprop, fenoxaprop-P, fenoxaprop-P-ethyl, fenoxasulfone, fenteracol, fenthiaprop, fenthiaprop, fentrazamide, fenuron, fenuron-TCA, ferrous sulfate, flamprop, flamprop-M, flamprop-M-isopropyl, flampropM-methyl, flazasulfuron, florasulam, florasulam, fluazifop, fluazifop-butyl, fluazifop-P, fluazifop-P-butyl, fluazolate, flucarbazone, flucarbazone, flucetosulfuron, fluchloralin, flufenacet (BAS FOE 5043), flufenican, flufenican, flufenpyr, flumetsulam, flumezin, flumiclorac, flumiclorac-pentyl, flumioxazin, flumipropyn, fluometuron, fluorodifen, fluoroglycofen, fluroglycof en-ethyl, fluoromidine, fluoronitrofen, fluothiuron, flupaxam, flupoxam, flupropacil, flupropanate, flupropanate-sodium, flupyrsulfuron, flupyrsulfuron-methylsodium, flurazole, flurenol, flurenol-butyl, fluridone, flurochloridone, fluroxypyr, fluroxypyr-2-butoxy-1-methylethyl, fluroxypyr-methyl, flurtamone, fluthiacet, fluthioacetmethyl, fluxofenim, fomesafen, fomesafen-sodium, foramsulfuron, fosamine, fosamine-ammonium, furilazole, furyloxyfen, glyphosate, glufosinate, glufosinate-ammonium, glufosinate-P, glyphosate ammonium, glyphosate-isopropylammonium, glyphosatesodium, glyphosate-trimesium, halosafen, halosafen, halosulfuron, halosulfuron-methyl, haloxydine, haloxyfop, haloxyfop-P, haloxyfop-P-methyl, haloxyfop-etotyl, haloxyf op-methyl, hexachloroacetone, hexaflurate, hexazinone, hilanafos, imazacluin, imazamethabenz, imazamox, imazapic, imazapyr, imazapyr-isopropylammonium, imazaquin, imazaquin-ammonium, imazemethabenz-methyl, imazethapyr, imazethapyr-ammonium, imazosulfuron, imizapic (AC 263222), indanofan, indaziflam, iodobonil, iodomethane, iodosulfuron, ioxynil, ioxynil octanoate, ioxynil-sodium, ipazine, ipfencarbazone, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, lactofen, laxynel octanoate, laxynil-sodium, lenacil, linuron, MAA, MAMA, MCPA, MCPA-butotyl, MCPA-dimethylammonium, MCPA-isoctyl, MCPA-potassium, MCPA-sodium, MCPA-thioethyl, MCPB, MCPB-ethyl, MCPB-sodium, mecoprop, mecoprop-P, medinoterb, mefenacet, mefenpyr-diethyl, mefluidide, mesoprazine, mesosulfuron, mesulfuron-methyl, mesotrione, metam, metamifop, metamifop, metamitron, metam-sodium, metezachlor, methalpropalin, methazole, metazosulfuron, metflurazon, methabenzthiazuron, methiobencarb, methiozolin, methiuron, methometon, methoprotryne, methyl bromide, methyl isothiocyanate, methylarsonic acid, methyldymron, metobenzuron, metobromuron, metolachlor, metosulam, metoxuron, metribuzin, metsulfuron, molinate, monalide, monisouron, monisouron, monochloroacetic acid, monolinuron, monuron, morfamquat, MPB-sodium, MSMA, napropamide, naptalam, naptalam-sodium, neburon, nicosulfuron, nonanoic acid, nipyraclofen, nitralin, nitrofen, nitrofluorfen, norflurazon, noruron, OCH, oleic acid (fatty acids), orbencarb, ortho-dichlorobenzene, orthosulfamuron, oryzalin, oxabetrinil, oxadiargyl, oxapyrazon, oxasulfuron, oxaziclomefone, oxodiazon, oxyfluorfen, parafluron, paraquat, paraquat dichloride, pebulate, pendimethalin, penoxsulam, penoxsulam, pentachlorophenol, pentachlorophenyl laurate, pentanochlor, pentoxazone, petroleum oils, perfluidone, pethoxamid, phenisopham, phenmedipham, phenmedipham-ethyl, phenobenzuron, phenylmercury acetate, picloram, picloram-potassium, picolinafen, picolinafen, pinoxaden, piperophos, potassium arsenite, potassium azide, potassium cyanate, pretilachlor, primisulfuron, primisulfuron-methyl, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, pyraflufen-ethyl, proxan, prynachlor, pydanon, pyraclonil, pyraflufen, pyrasulfotole, pyrazolynate, pyrazasulfuron, pyrazosulfuron, pyrazoxyfen, pyrazolynate, pyrazosulfuron-ethyl, pyrazoxyfen, pyriben-zoxim, pyributicarb, pyriclor, pyridafol, pyridate, pyriftalid, pyriminobac, pyriminobac-methyl, pyrimisulfan, pyrithiobac, pyrithiobac-sodium, pyroxasulfone, pyroxasulfone, pyroxsulam, pyroxsulam, pyroxsulam, quinclorac, quinmerac, quinoclamine, quinofola-mine, quinonamid, quizalofop, quizalofop-ethyl, quizalofop-P, quizalofop-P-ethyl, quizalofop-P-tefuryl, rimsulfuron, rhodethanil, saflufenacil, saflufenacil, sebuthylazine, secbumeton, sethoxydim, siduron, simazine, simeton, simetryn, SMA, S-metolachlor, sodium arsenite, sodium azide, sodium chlorate, sodium chloroacetate, sodium pentachlorophenoxide, sodium-dimethylarsinate, sulcotrione, sulfallate, sulfentrazone, sul-fometuron, sulfometuron-methyl, sulfosulfuron, sulfuric acid, sulglycapin, swep, tars, TCA-sodium, tebutam, tebuthiuron, tepraloxydim, tepraluxydim (BAS 620H), terbacil, terbucarb, terbuchlor, terbumeton, terbuthylazine, terbutryn, tetrafluron, thenylchlor, thiazafluron, thiazopyr, thidiazimin, thidiazuron, thidiazuron, thiencarbazone, thifensulfuron, thifensulfuron-methyl, thiobencarb, tiocarbazil, tioclorim, topramezone, topramezone, tralkoxydim, triallate, triasulfuron, triaziflam, tribenuron, tribenuron-methyl, tribenuron-methyl, tricamba, trichloroacetic acid, triclopyr, triclopyr-butotyl, triclopyr-triethylammonium, tridiphane, trietazine, trifloxysulfuron, trifluralin, triflusulfuron, triflusulfuron-methyl, trifop, trifopsime, trihydroxytriazine, trimeturon, tripropindan, tritac, tritosulfuron, 2, 4, 5-T, 2,4,5-TB, 2, 3, 6-TBA, TCA, tebutam, tebuthiuron, tefuryltrione, tembotrione, vernolate: YRC 2388, and xylachlor among others. Each possibility represents as separate embodiment of the present invention.

In another embodiment, the growth regulators is selected from the group consisting of abscisic acid, ACC, ancymidol, aviglycine, benzofluor, benzyladenine, brassinolide, buminafos, butralin, calcium cyanamide, carbaryl, carvone, chlorfluren, chlorflurenol, chlormequat, chlorphonium, chlorpropham, ciobutide, clofencet, clofibric acid, cloxyfonac, 4-CPA, cyanamide, cyclanilide, cycloheximide, cyprosulf amide, 2,4-D, daminozide, 2,4-DB, 2,4-DEP, dichlorflurenol, dichlorprop, dikegulac, dimethipin, endothal, epocholeone, etacelasil, ethephon, ethychlozate, ethylene, fenoprop, fenridazon, flumetralin, fluoridamid, flurenol, flurprimidol, forchlorfenuron, fosamine, gibberellic acid, gibberellins, glyoxime, glyphosine, heptopargil, holosulf, hymexazol, IAA, IBA, inabenfide, isopyrimol, jasmonic acid, karetazan, kinetin, lead arsenate, maleic hydrazide, mefluidide, mepiquat, merphos, methasulfocarb, 1-methylcyclopropene, metoxuron, α-naphthaleneacetic acid, naphthaleneacetamide, 1-naphthol, naphthoxyacetic acid, 2iP, paclobutrazol, pentachlorophenol, piproctanyl, potassium naphthenate, prohexadione, prohydrojasmon, propham, pydanon, sintofen, sodium naphthenate, 2,4, 5-T, tetcyclacis, thidiazuron, triapenthenol, tribufos, 2,3,5-tri-iodobenzoic acid, trinexapac, uniconazole and zeatin among others. Each possibility represents as separate embodiment of the present invention.

In another embodiment, the insecticide, acaricide and nematocide active substances are selected from the group consisting of: abamectin, acephate, acetamiprid, acethion, acetoprole, acrinathrin, acrylonitrile, aldicarb, alanycarb, aldoxycarb, aldrin, allethrin [(1R) isomers], a-cypermethrin, allosamidin, allyxycarb, α-cypermethrin, α-endosulfan, amidithion, aminocarb, amiton, amitraz, anabasine, athidathion, avermectin B 1 and its derivatives, azadirachtin, azamethiphos, azinphos-ethyl, azinphos-methyl, azinphosmethyl, azothoate, bacillus thurigiensi, barium hexafluorosilicate, barthrin, bendiocarb, benfuracarb, bensultap, β-cyfluthrin, β-cypermethrin, bifenazate, bifenthrin, bioallathrin, bioallethrin (S-cyclopentenyl isomer), bioethanomethrin, biopermethrin, bioresmethrin, bistrifluron, borax, boric acid, bromfenvinfos, bromocyclen, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, cartap hydrochloride, chlorantraniliprole, chlorbicyclen, chordane, chlordecone, chlordimeform, chlorethoxyfos, chlorfenapyr, chlorfenvimphos, chlorfluazuron, chlonnephos, chloroform, chloropicrin, chlorphoxim, chlorprazophos, chlorpyrifos, chlorpyrifos-methyl, chlorthiophos, chromafenozide, cinerin I, cinerin Π, cinerins, cismethrin, cloethocarb, closantel, clothianidin, clothianidin, copper acetoarsenite, copper arsenate, copper naphthenate, copper oleate, coumaphos, cryolite, cryomazine, cyanophos, calcium cyanide, sodium cyanide, coumithoate, crotamiton, crotoxyphos, crufomate, cryolite, cyanofenphos, cyanophos, cyanthoate, cyantraniliprole, cyantraniliprole, cyclethrin, cycloprothrin, cyfluthrin, cyhalothrin, cypermethrin, cyphenothrin [(1R) transisomers], 13-cyfluthrin; 13-cypermethrin, cyromazine, cythioate, dazomet, DDT, decarbofuran, deltamethrin, demephion, demephion-O, demephion-S, demeton, demeton-methyl, demeton-0, demeton-O-methyl, demeton-S, demeton-S-methyl, demeton-S-methylsulphon, diafenthiuron, dialifos, diatomaceous earth, diazinon, dicapthon, dichlofenthion, 1,2-dichloropropane, dichlorvos, dicofol, dicresyl, dicrotophos, dicyclanil, dieldrin, diflubenzuron, dilor, dimefluthrin, dimefox, dimetan, dimethoate, dimethrin, dimethylvinphos, dimetilan, dimetilan, dinex, dinoprop, dinosam, dinotefuran, diofenolan, dioxabenzofos, dioxacarb, dioxathion, disulfoton, dithicrofos, d-limonene, doramectin, DNOC, DPXJW062 and DP, a-ecdysone, ecdysterone, emamectin, EMPC, empenthrin [(EZ)-(IR) isomers], endosulfan, ENT 8184, EPN, endothion, endrin, EPN, epofenonane, eprinomectin, esfenvalerate, etaphos, ethiofencarb, ethion, ethoate-methyl, ethoprophos, ethyl formate, ethyl-DDD, ethylene dibromide, ethylene dichloride, ethiprole, ethylene oxide, etofenprox, etoxazole, etrirnfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil and the compounds of the arylpyrazole family, flonicamid, flubendiamide, flucofuron, flucycloxuron, flucythrinate, flufenerim, flufenoxuron, flufenprox, flumethrin, fluofenprox, fluvalinate, fonofos, formetanate, formparanate, formetanate hydrochloride, formothion, fosmethilan, fospirate, fosthietan, furathiocarb, furethrin, gamma-cyhalothrin, γ-HCH, GY-81, halfenprox, halofenozide, HCH, HEOD, heptachlor, heptenophos, heterophos, hexaflumuron, sodium hexafluorosilicate, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isofenphos-methyl, isoprocarb, isoprothiolane, isothioate, methyl isothiocyanal, isoxathion, ivermectin, jasmolin I, jasmolin II, jodfenphos, juvenile hormone I, juvenile hormone II, juvenile hormone III, kelevan, kinoprene, λ-cyhalothrin, pentachlorophenyl laurate, lead arsenate, lepimectin, leptophos, lindane, lirimfos, lufenuron, lythidathion, malathion, MB-599, malonoben, mazidox, mecarbam, mecarphon, menazon, mephosfolan, mercurous chloride, mesulfenfos, metaflumizone, methacrifos, methamidophos, methidathion, methiocarb, methocrotophos, methomyl, methoprene, methoxychlor, methoxyfenozide, methyl bromide, methylchloroform, methylene chloride, metofluthrin, metolcarb, metoxadiazone, mevinphos, mexacarbate, milbemectin and its derivatives, milbemycin oxime, mipafox, mirex, monocrotophos, morphothion, moxidectin, naftalofos, naled, naphthalene, nicotine, nifluridide, nitenpyram, nithiazine, nitrilacarb, novaluron, noviflumuron, petroleum oils, tar oils, oleic acid, omethoate, oxamyl, oxydemeton-methyl, oxydeprofos, oxydisulfoton, paecilomyces fumosoroseus, para-dichlorobenzene, parathion, parathion-methyl, penfluron, pentachlorophenol, sodium pentachlorophenoxide, permethrin, phenkapton, phenothrin [(1R)-transisomers], phenthoate, phorate, phosalone, phosfolan, phosmet, phosphamidon, piperonyl butoxide, phosphine, aluminum phosphide, magnesium phosphide, zinc phosphide, phosnichlor, phosphamidon, phosphine, phoxim, phoxim-methyl, pirimetaphos, pirimicarb, pirimiphos-ethyl, pirimiphos-methyl, calcium polysulfide, plifenate, potassium arsenite, potassium thiocyanate, pp′-DDT, pralletiirin, precocene I, precocene Π, precocene IΠ, primidophos, profenfos, profluthrin, promacyl, promecarb, propaphos, propetamphos, propoxur, prothidathion, prothiofos, prothoate, protrifenbute, pyraclofos, pyrafluprole, pyrazophos, pyresmethrin, pyrethrin I, pyrethrin Π, pyrethrins (chrysanthemates, pyrethrates, pyrethrum), pyretrozine, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, RH-2485, rotenone, RU 15525, ryania, sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulcofuron-sodium, sulfluramide, sulfotep, sulfoxaflor, sulfuryl fluoride, sulprofos, ta-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethrin [(1R) isomers], tetramethylfluthrin, τ-cypermethrin, O-cypermethrin, thiacloprid, thiametoxam, thicrofos, thiocarboxime, thiocyclam, thiocyclam hydrogen oxalate, thiodicarb, thiofanox, thiometon, thiosultap, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XDE-105, XMC, xylylcarb, ζ-cypermethrin, zolaprofos, and ZXI 8901 among others. Each possibility represents as separate embodiment of the present invention.

In a currently preferred embodiment, the agrochemical (covalently conjugated as a hydrophobic end group and/or non-covalently encapsulated within the micelle) are each independently selected from the group consisting of abscisic acid, indole acetic acid, 2,4-dichlorophenoxyacetic acid, 2,4,5-trichlorophenoxyacetic acid, salicylic acid, 2,3,6-trichlorobenzoic acid, benzoylprop, carfentrazone, chlorfenprop, cloquintocet, diclofop, diethatyl, fenoxaprop, fluoroglycofen, haloxyfop, iodosulfuron, MCPB, quizalofop-p, bufencarb, ethiofencarb, fenobucarb, clofibric acid, α-naphthaleneacetic acid, gibberellic acid, jasmonic acid, and derivatives thereof. Each possibility represents as separate embodiment of the present invention.

The term “derived from” as used herein means a moiety that is derived from an agrochemical and that is incorporated into the hybrid systems of the present invention. A derivative of an active moiety may be formed, e.g., by removing one or more of the atoms of said agrochemical or adding one or more atoms or functional groups so as to chemically conjugate it to the dendron.

### Chemical Definitions

The term “C1-C4/C1-C20 alkylene” used herein alone or as part of another group denotes a bivalent radicals of 1 to 4/20 carbons, which is bonded at two positions connecting together two separate additional groups (e.g., CH₂). Examples of alkylene groups include, but are not limited to —(CH₂)—, (CH₂)₂, (CH₂)₃, (CH₂)₄, etc.

The term “C2-C20 alkenylene” denotes a bivalent radical of 2 to 20 carbons which contains at least one double bond, which is bonded at two positions connecting together two separate additional groups (e.g., —CH═CH—).

The term “C2-C20 alkynylene” denotes a bivalent radicals of 2 to 20 carbons containing at least one triple bond, which is bonded at two positions connecting together two separate additional groups (e.g., —C≡C—).

The term “arylene” denotes a bivalent radicals of aryl, which is bonded at two positions connecting together two separate additional groups.

The term “acyclic hydrocarbon” used herein denotes to any linear or branched, saturated and mono or polyunsaturated carbon atoms chain, or the residue of such compound after it has chemically bonded to another molecule. Preferred are acyclic hydrocarbon moieties containing from 1 to 20 carbon atoms. The acyclic hydrocarbon of the present invention may comprise one or more of an alkyl, an alkenyl, and an alkynyl moieties. Examples of acyclic hydrocarbon include, but are not limited to, n-propyl, isopropyl, n-butyl, sec-butyl, isobutyl and tert-butyl, n-pentyl, n-hexyl, vinyl, allyl, butenyl, pentenyl, ropargyl, butynyl, pentynyl, and hexynyl. Each possibility represents as separate embodiment of the present invention.

The term “cyclic hydrocarbon” generally refers to a C3 to C8 cycloalkyl or cycloalkenyl which includes monocyclic or polycyclic groups. Non-limiting examples of cycloalkyl groups are cyclopropyl, cyclobutyl, cyclopentyl, cyclohexyl or cycloheptyl. The cycloalkyl group can be unsubstituted or substituted with any one or more of the substituents defined above for alkyl.

The term “aromatic hydrocarbon” used herein denotes to an aromatic ring system containing from 6-14 ring carbon atoms. The aryl ring can be a monocyclic, bicyclic, tricyclic and the like. Non-limiting examples of aryl groups are phenyl, naphthyl including 1-naphthyl and 2-naphthyl, and the like. Each possibility represents as separate embodiment of the present invention. The aryl group can be unsubstituted or substituted through available carbon atoms with one or more groups defined hereinabove for alkyl.

The terms “heterocyclic” or “heterocyclyl” used herein alone denote a five-membered to eight-membered rings that have 1 to 4 heteroatoms, such as oxygen, sulfur and/or nitrogen. These five-membered to eight-membered rings can be saturated, fully unsaturated or partially unsaturated. Preferred heterocyclic rings include piperidinyl, pyrrolidinyl, pyrrolinyl, pyrazolinyl, pyrazolidinyl, piperidinyl, morpholinyl, thiomorpholinyl, pyranyl, thiopyranyl, piperazinyl, indolinyl, dihydrofuranyl, tetrahydrofuranyl, dihydrothiophenyl, tetrahydrothiophenyl, dihydropyranyl, tetrahydropyranyl, and the like. Each possibility represents as separate embodiment of the present invention. The heterocyclyl group can be unsubstituted or substituted through available atoms with one or more groups defined hereinabove for alkyl.

The term “heteroaryl” used herein denotes a heteroaromatic system containing at least one heteroatom ring atom selected from nitrogen, sulfur and oxygen. The heteroaryl generally contains 5 or more ring atoms. The heteroaryl group can be monocyclic, bicyclic, tricyclic and the like. Also included in this expression are the benzoheterocyclic rings. If nitrogen is a ring atom, the present invention also contemplates the N-oxides of the nitrogen containing heteroaryls. Non-limiting examples of heteroaryls include thienyl, benzothienyl, 1-naphthothienyl, thianthrenyl, furyl, benzofuryl, pyrrolyl, imidazolyl, pyrazolyl, pyridyl, pyrazinyl, pyrimidinyl, pyridazinyl, indolyl, isoindolyl, indazolyl, purinyl, isoquinolyl, quinolyl, naphthyridinyl, quinoxalinyl, quinazolinyl, cinnolinyl, pteridinyl, carbolinyl, thiazolyl, oxazolyl, isothiazolyl, isoxazolyl and the like. Each possibility represents as separate embodiment of the present invention. The heteroaryl group may optionally be substituted through available atoms with one or more groups defined hereinabove for alkyl.

Any of the moieties described herein (e.g., alkeylene, alkenylene, alkynylene, arylene, acyclic and cyclic hydrocarbons, heterocyclic and heteroaromatic moieties) may be unsubstituted, or substituted with one or more substituents selected from the group consisting of halogen, hydroxy, alkoxy, aryloxy, alkylaryloxy, heteroaryloxy, oxo, cycloalkyl, phenyl, heteroaryl, heterocyclyl, naphthyl, amino, alkylamino, arylamino, heteroarylamino, dialkylamino, diarylamino, alkylarylamino, alkylheteroarylamino, arylheteroarylamino, acyl, acyloxy, nitro, carboxy, carbamoyl, carboxamide, cyano, sulfonyl, sulfonylamino, sulfinyl, sulfinylamino, thiol, C₁ to C₄ alkylthio, arylthio, or C₁ to C₄ alkylsulfonyl groups. Any substituent can be unsubstituted or further substituted with any one of these aforementioned substituents. Each possibility represents as separate embodiment of the present invention.

All stereoisomers, optical and geometrical isomers of the compounds of the instant invention are contemplated, either in admixture or in pure or substantially pure form. The compounds of the present invention can have asymmetric centers at any of the atoms. Consequently, the compounds can exist in enantiomeric or diastereomeric forms or in mixtures thereof. The present invention contemplates the use of any racemates (i.e., mixtures containing equal amounts of each enantiomers), enantiomerically enriched mixtures (i.e., mixtures enriched for one enantiomer), pure enantiomers or diastereomers, or any mixtures thereof. The chiral centers can be designated as R or S or R,S or d,D, l,L or d,l, D,L. In addition, several of the compounds of the invention contain one or more double bonds. The present invention intends to encompass all structural and geometrical isomers including cis, trans, E and Z isomers, independently at each occurrence.

One or more of the compounds of the invention, may be present as a salt. The term “salt” encompasses both basic and acid addition salts, including but not limited to phosphate, dihydrogen phosphate, hydrogen phosphate and phosphonate salts, and include salts formed with organic and inorganic anions and cations. Furthermore, the term includes salts that form by standard acid-base reactions of basic groups and organic or inorganic acids. Such acids include hydrochloric, hydrofluoric, hydrobromic, trifluoroacetic, sulfuric, phosphoric, acetic, succinic, citric, lactic, maleic, fumaric, cholic, pamoic, mucic, D-camphoric, phthalic, tartaric, salicyclic, methanesulfonic, benzenesulfonic, p-toluenesulfonic, sorbic, picric, benzoic, cinnamic, and like acids. Additional salts of the conjugates described herein may be prepared by reacting the parent molecule with a suitable base, e.g., NaOH or KOH to yield the corresponding alkali metal salts, e.g., the sodium or potassium salts. Additional basic addition salts include ammonium salts (NH₄⁺), substituted ammonium salts, Li, Ca, Mg, salts, and the like.

Uses

In another aspect, the present invention provides a method of delivering the amphiphilic hybrid system comprising the step of contacting a plant or the plant surroundings with the amphiphilic hybrid delivery system, and an enzyme or a pH adjusting agent in an amount effective to induce cleavage of the hydrophobic end group, thereby disassembling said micelle and release its cargo agrochemical.

As used herein, the term “pH adjusting agent” and “pH adjuster” are interchangeable and refer to inorganic and organic acids and bases. The pH adjusting agent preferred for use in the present invention are chemicals certified as generally recognized as safe for human consumption by the US Food and Drug Administration.

According to some embodiments, one or more pH adjusters may be used to induce cleavage of the cleavable moiety. According to other embodiments, a buffer agent may be added to the pH adjusting agent to maintain the essential pH for the cleavage. To this end, any pH adjusting agent that is compatible with the intended use and with the amphiphilic hybrid system of the present invention may be used. Suitable inorganic acids include, but are not limited to, sulfuric acid, sodium bisulfate, phosphoric acid, nitric acid, hydrochloric acid, sulfuric acid, phosphoric acid, hydroiodic acid, hydrobromic acid, hydrofluoric acid, trifluoroacetic acid, sulfuric acid, phosphoric acid, sodium borate, sodium phosphate, sodium pyrophosphate, p-toluenesulfonic acid, sodium aluminum sulphate, or suitable mixtures of two or more thereof. Each possibility represents as separate embodiment of the present invention.

Suitable organic acids include, but are not limited to, linear alkyl benzene sulfonic acids (LABSA), benzene sulfonic acid, succinic acid, formic acid, acetic acid, mono, di, or tri-halocarboyxlic acids, picolinic acid, dipicolinic acid, lactic acid, citric acid, maleic acid, cholic acid, pamoic acid, camphoric acid, phthalic acid, tartaric acid, salicyclic acid, glucono-delta-lactone, sorbic acid, benzoic acid, cinnamic acid oxalic acid and uric acid or suitable mixtures of two or more thereof. Each possibility represents as separate embodiment of the present invention.

Suitable inorganic base pH adjusting agents include, but are not limited to, alkali metal hydroxides (e.g., sodium hydroxide and potassium hydroxide), ammonium hydroxide, alkali metal bicarbonate, (e.g., sodium bicarbonate, and potassium bicarbonate), alkali metal carbonate (e.g., lithium carbonate and potassium carbonate,) or suitable mixtures of two or more thereof. Each possibility represents as separate embodiment of the present invention.

Suitable organic base pH adjusting agents include, but are not limited to, monoethanolamine, triethanolamine, diisopropylamine, dodecylamine, diisopropanolamine, aminomethyl propanol, cocamine, oleamine, morpholine, triamylamine, triethylamine, tromethamine(2-amino-2-hydroxymethyl)-1,3-propanediol), N,N,N′,N′-tetrakis(hydroxy propyl)ethylenediamine, or suitable mixtures of two or more thereof. Each possibility represents as separate embodiment of the present invention.

As used herein, the term “contacting” refers to bringing to immediate or close proximity with the amphiphilic hybrid delivery system of the present invention. Contacting can be accomplished by any means, such as by spraying, sprinkling, irrigating, adding to water or other liquids provided to plant, adding as a solid, dry product, for example, by spreading, or tilling into the soil.

As used herein, the term “contacting a plant or the plant surroundings” refers to any part of the plant (such as roots, tree branches, foliages, shoots, flowers and fruits), seeds, the soil around the plants, and/or the irrigation water. Contacting the plant surroundings may also include living organisms (such as microorganisms and animals) present at the surrounding of the plant. Each possibility represents as separate embodiment of the present invention.

An “effective amount” generally means an amount which provides the desired effect.

Kits

In another aspect, the present invention provides a kit for delivering the amphiphilic hybrid system comprising in one compartment the agrochemical amphiphilic hybrid system; and in a second compartment an enzyme or a pH adjusting agent capable of hydrolyzing the hydrophobic end group so as to disassemble said micelle and release its cargo agrochemical.

The kit may further include appropriate buffers and reagents known in the art for contacting the compartments listed above to a plant or the plant surroundings. The amphiphilic hybrid delivery system and the enzyme may be provided in solution and/or in lyophilized form. When the enzyme is in a lyophilized form, the kit may optionally contain a sterile and physiologically acceptable reconstitution medium such as water, saline, buffered saline, and the like. The pH adjusting agent may be provided in solution or solid form.

According to some embodiments, associated with such compartments may be various written materials such as instructions for use.

The examples hereinbelow are presented in order to more fully illustrate some embodiments of the invention. They should, in no way be construed, however, as limiting the broad scope of the invention. One skilled in the art may readily devise many variations and modifications of the principles disclosed herein without departing from the scope of the invention.

### Examples

### Example 1—Materials and Methods

Materials:

Poly (Ethylene Glycol) methyl ether (2 kDa, 5 kDa and 10 kDa), 2-(Boc-amino)-ethanethiol (97%), 2,2-dimethoxy-2-phenylacetophenone (DMPA, 99%), Penicillin G Amidase from Escherichia coli (PGA), Esterase from porcine liver (PLE), Allyl bromide (99%), 4-Nitrophenol (99.5%), N,N′-dicyclohexylcarbodiimide (DCC, 99%), Sephadex® LH20 and dry DMF were purchased from Sigma-Aldrich. Cystamine hydrochloride (98%), potassium hydroxide and DIPEA were purchased from Merck. Trifluoroacetic acid (TFA) was purchased from Alfa Aesar and phenyl acetic acid was purchased from Fluka. Silica Gel 60 Å, 0.040-0.063 mm, sodium hydroxide and all solvents were purchased from Bio-Lab and were used as received. All solvents are HPLC grade. Deuterated solvents for NMR were purchased from Cambridge Isotope Laboratories, Inc.

Instrumentation:

HPLC: All measurements were recorded on a Waters Alliance e2695 separations module equipped with a Waters 2998 photodiode array detector. ¹H and ¹³C NMR: spectra were recorded on Bruker Avance I and Avance III 400 MHz spectrometers. GPC: All measurements were recorded on Viscotek GPCmax by Malvern using refractive index detector. Infrared spectra: All measurements were recorded on a Bruker Tensor 27 equipped with a platinum ATR diamond. Fluorescence spectra: All measurements were recorded on an Agilent Technologies Cary Eclipse Fluorescence Spectrometer using quartz cuvettes. CMC: All measurements were recorded on a TECAN Infinite M200Pro device. MALDI-TOF MS: Analysis was conducted on a Bruker AutoFlex MALDI-TOF MS and also on a Waters MALDI synapt. DHB matrix was used. TEM: Images were taken by a Philips Tecnai F20 TEM at 200 kV. DLS: All measurements were recorded on a Malvern Zetasizer NanoZS.

Methods

### NMR

Chemical shifts are reported in ppm and referenced to the solvent. The molecular weights of the PEG-dendron hybrids are determined by comparison of the areas of the peaks corresponding to the PEG block (3.63 ppm) and the protons peaks of the dendrons.

### Gel Permeation Chromatography (GPC)

### Instrument Method:

### Columns: 2×PSS GRAM 1000 Å+PSS GRAM 30 Å

### Columns Temperature: 50° C.

How rate: 0.5 ml/min
Mobile phase: DMF+50 mM LiBr
Detector: Refractive index detector at 50° C.

### Injection Volume: 15 μL

### General Sample Preparation:

PEG product is dissolved in mobile phase to give a final concentration of 10 g/ml. Solution is filtered through a 0.22 μm PTFE syringe filter. PEG standards (purchased from Sigma-Aldrich) were used for calibration.

### Critical Micelle Concentration (CMC) Measurements

### Instrument Method:

### Excitation: 550 nm

Emission intensity scan: 580-800 nm

### General Procedure:

Into 100 ml PBS solution (pH 7.4), 45 μL of Nile red stock solution (0.88 mg/ml in Ethanol) is added and mixed to give a final concentration of 1.25 μM. Then, the amphiphilic hybrids of the present invention are dissolved directly into aqueous buffer solution (PBS, pH 7.4). Each solution is sonicated for 15 minutes and then filtered through a 0.22 μm nylon syringe filter. This solution is repeatedly diluted by a factor of 2 with diluent. 100 μL of each solution are loaded onto a 96 wells plate. The fluorescence emission intensity is scanned for each well. Maximum emission intensity is plotted vs. concentration in order to determine the CMC.

### Dynamic Light Scattering (DLS) Measurements

### General Sample Preparation:

The amphiphilic hybrids of the invention are dissolved in PBS buffer (pH 7.4) to give a final concentration of 160 μM. Each solution is sonicated for 15 minutes and filtered through a 0.22 μm nylon syringe filter. 800 μL of each solution is accurately transferred into a polystyrene cuvette and a measurement is performed (t=0).

### Micelle Degradation in the Presence of 0.14 μM PGA/PLE Enzyme:

0.8 μL of PGA or PLE enzyme stock solution (140 μM in PBS buffer pH 7.4) is added to 800 tit of each PEG-dendron hybrid solution (160 μM). Repeating measurements are performed every 2 hours.

### Micelle Degradation in the Presence of 1.4 μM PGA/PLE Enzyme:

8 μL of PGA or PLE enzyme stock solution (140 μM in PBS buffer pH 7.4) is added to 800 μL of each PEG-dendron hybrid solution (160 μM). Repeating measurements are performed every 3 minutes.

### Transmission Electron Microscopy (TEM) Measurements

### General Sample Preparation:

5 mL sample solution is dropped cast onto carbon coated copper grids and inspected in a transmission electron microscope (TEM), operated at 200 kV (Philips Tecnai F20). The excessive solvent of the droplet is wiped away using a solvent-absorbing filter paper after 1 min and the sample grids are left to dry in air at room temperature for 5 minutes. This procedure is repeated three times. After the third cycle the sample grids are left to dry in air at room temperature overnight.

### Nile Red Fluorescence Measurements

### Instrument Method:

### Excitation: 550 nm

Emission scan: 575-800 nm
Excitation and Emission slits width: 20 nm
Scan rate: 600 nm/min

### General Sample Preparation and Measurement:

The amphiphilic hybrids of the invention are dissolved in PBS buffer (pH 7.4) to give a concentration of 160 μM. Each solution is sonicated for 15 minutes and then filtered through a 0.22 μm nylon syringe filter. 2.0 mL of this solution are accurately transferred to a quartz cuvette and 0.9μL of Nile Red stock solution (0.88 mg/mL in Ethanol) is added to give a final concentration of 1.25 μM. A fluorescence emission scan is performed (t=0) and then 2.0μL of PGA or PLE enzyme stock solution (140 μM in PBS buffer pH7.4) is added to give a final concentration of 0.14 μM. Repeating fluorescence scans are performed every 15 minutes for 20 hours.

Enzymatic Degradation with HPLC

### Instrument Method:

### Column: Phenomenex, Luna, C18, 150×4.6 mm, 5 μm.

### Column Temperature: 30° C.

Mobile Phase: Solution A: 0.1% TFA in H₂O:Acetonitrile 95:5 V/V. Solution B: 0.1% TFA in H₂O:Acetonitrile 5:95 V/V.

### Gradient Program:

| Time | % Sol. | % Sol. |
|---|---|---|
| [min] | A | B |
| 0 | 100 | 0 |
| 20.0 | 0 | 100 |
| 23.0 | 0 | 100 |
| 23.1 | 100 | 0 |
| 30.0 | 100 | 0 |

Injection volume: 20μL.
Detector: UV at 295 nm, 2 Hz detection rate.
Needle Wash: 0.1% concentrated H₃PO₄ in MeOH.
Seal wash solution: H₂O:MeOH 90:10 V/V.
Diluent: PBS buffer pH7.4.

### General Sample Preparation and Measurement:

The hybrids of the invention are dissolved in diluent to give a concentration of 160 μM. Each solution is sonicated for 15 minutes and then filtered through a 0.22 μm nylon syringe filter. Then, 20 μL of each solution 20 μL is injected to the HPLC as t=0 injection. Stock solution of the enzyme (PGA or PLE) in PBS (pH 7.4) is added and mixed manually. Enzymatic degradation is monitored at several time points by repeating 20 μL injections from the same solution over time.

### Example 2: Synthesis of Amphiphilic PEG-Dendron Hybrids

2,4-D was used as a preliminary model compound, which is conjugated to the hydroxy end-groups of the dendron through ester linkages (Scheme 1). These esters can potentially be cleaved by either pH-dependent or enzymatic hydrolysis, to release the parent active herbicide 2,4-D.

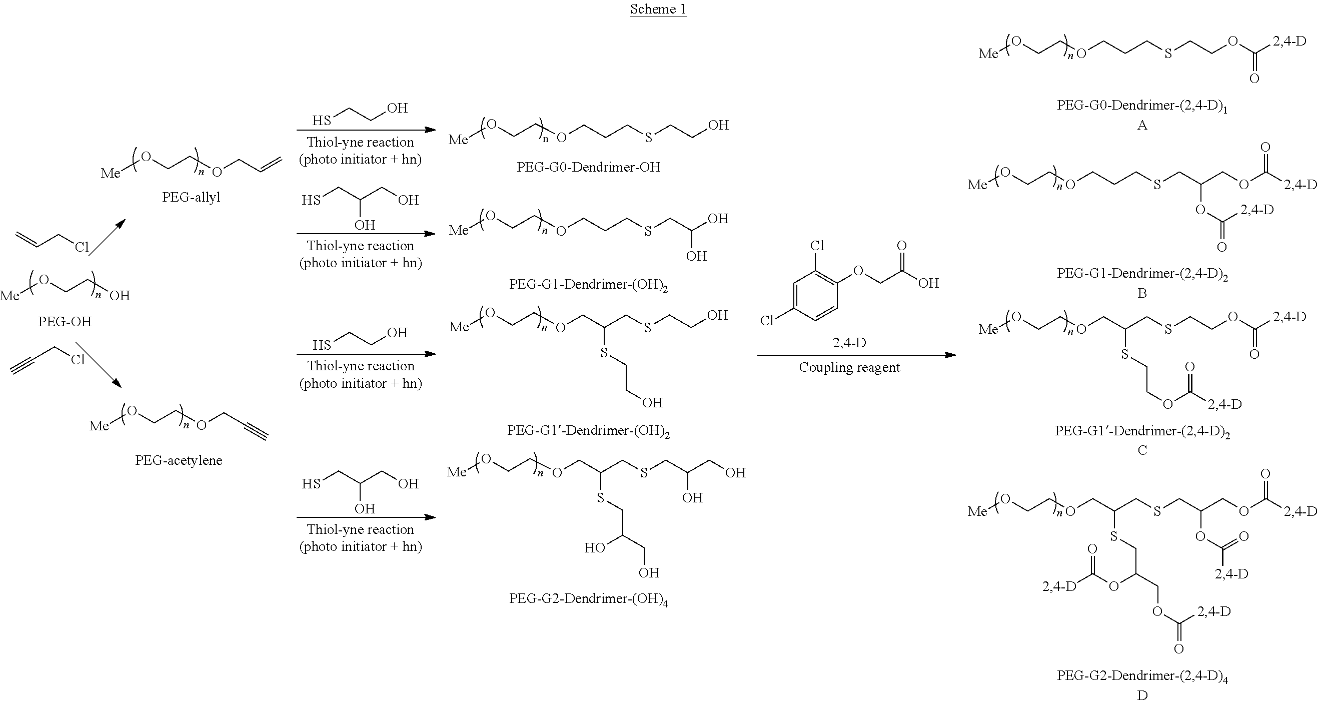

The utilization of ester linkages from either primary or secondary hydroxyls enables further control over the hydrolysis rate in addition to the length of the PEG and dendrons' generation. The synthesis of a second-generation dendron with primary ester linkages and a third-generation dendron are as illustrated in Scheme 2.

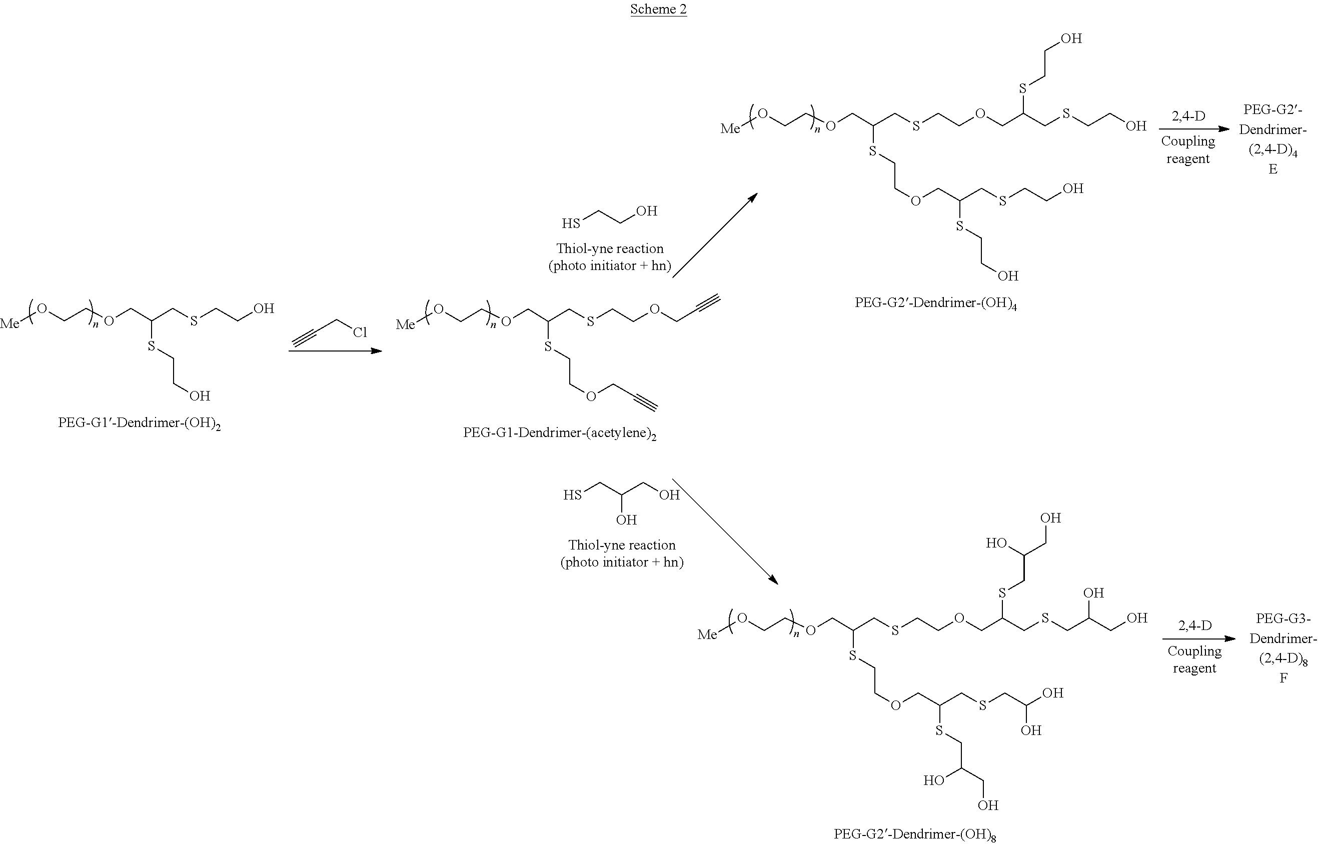

### Example 3: Synthesis of Alternative Amphiphilic PEG-Dendron Hybrids (1a-1c)

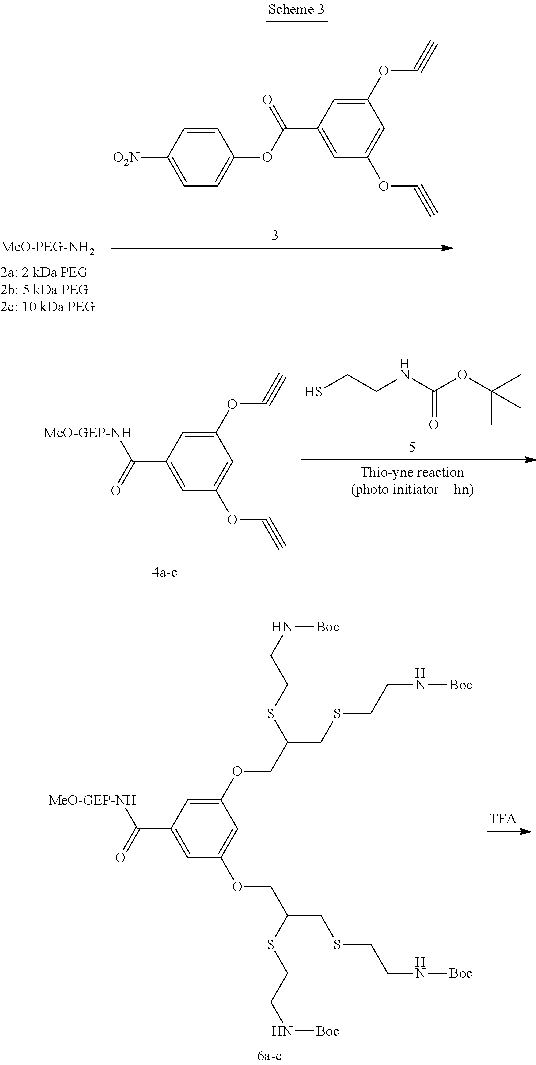

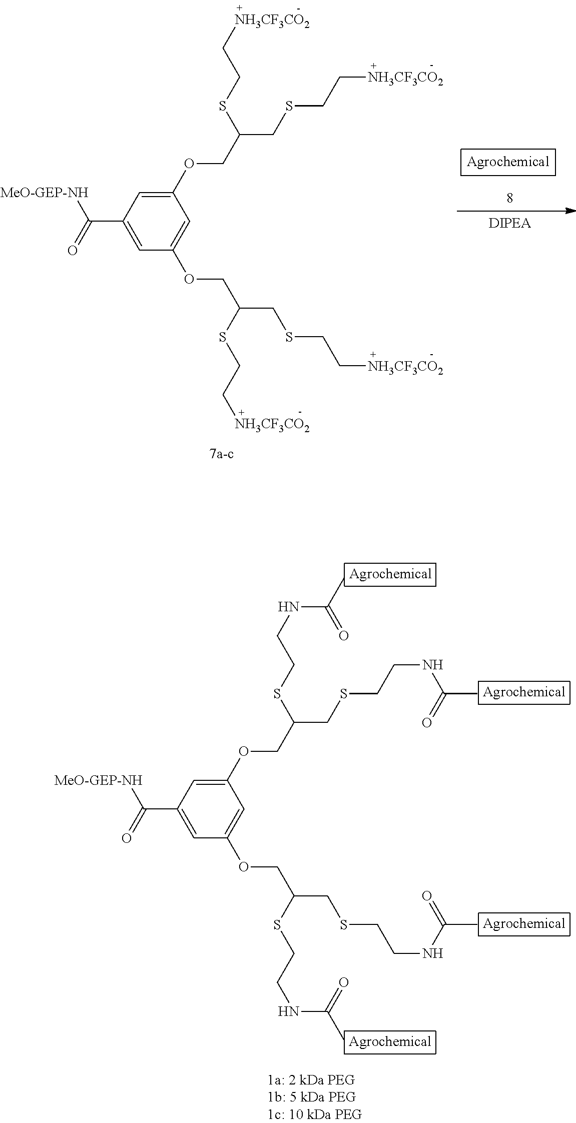

In the above scheme, MeO-PEG-NH₂ (compounds 2a-2c) is represented by the structure shown in Scheme 4.

The amphiphilic hybrids (1a-c) of the invention may be prepared by the process described in general Scheme 3 hereinabove. Briefly, the hybrid block copolymers are synthesized utilizing mono-methyl ether PEG-amine, 2a-c, as starting materials. Conjugation with an active ester of 3,5-bis(prop-2-yn-1-yloxy)benzoic acid, 3, yielded PEG-di-yne, 4a-c. The latter are further modified by thiol-yne reaction with N-Boc cysteamine, 5, to give tetra-functionalized PEG-dendrons, 6a-c, followed by deprotection of the Boc to yields PEG-tetra-amine, 7a-c. In the last step of the synthesis, the agrochemical compound, 8, is used to introduce the enzyme cleavable hydrophobic surface-groups.

The synthesized polymers and hybrids are characterized by ¹H and ¹³C-NMR, GPC, IR and MALDI in order to confirm their structures.

### General Procedure for MeO-PEG-Allyl Compounds 2a-c

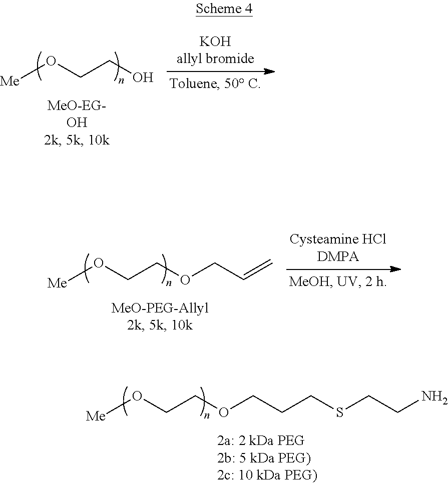

MeO-PEG-Allyl precursors may be prepared by the process described in general Scheme 4 hereinabove. Poly (ethylene glycol) methyl ether was dissolved in toluene (10 mL per 1 g) with KOH (10 eq.). The solution was refluxed for at least 1 hour using a Dean Stark water separation system. Solution was cooled down to 50° C. and then allyl bromide (10 eq.) was added slowly and the reaction was stirred overnight. The solution was filtered hot through celite, the celite was then washed with DCM. Solvents were evaporated in vacuum and the residue was re-dissolved in DCM (5 mL per 1 g PEG). MeO-PEG-Allyl product was precipitated by the dropwise addition of 1:1 v/v Ether:Hexane mixture (50 mL per 1 g PEG). Precipitate was filtered and washed with ether and then with hexane. The final white solid product was dried under high vacuum.

MeO-PEG-Allyl precursors may be prepared by the process described in general Scheme 4 hereinabove. Poly (ethylene glycol) methyl ether was dissolved in toluene (10 mL per 1 g) with KOH (10 eq.). The solution was refluxed for at least 1 hour using a Dean Stark water separation system. Solution was cooled down to 50° C. and then allyl bromide (10 eq.) was added slowly and the reaction was stirred overnight. The solution was filtered hot through celite, the celite was then washed with DCM. Solvents were evaporated in vacuum and the residue was re-dissolved in DCM (5 mL per 1 g PEG). MeO-PEG-Allyl product was precipitated by the dropwise addition of 1:1 v/v Ether:Hexane mixture (50 mL per 1 g PEG). Precipitate was filtered and washed with ether and then with hexane. The final white solid product was dried under high vacuum.

MeO-PEG2 kDa-Allyl:

3.00 g (1.5 mmol) Poly (ethylene glycol) methyl ether (Mₙ=2 kDa) were reacted according to the general procedure (I) and the product was obtained as a white solid (2.42 g) 80% yield. ¹H-NMR (CDCl₃): δ 5.85-5.95 (m, 1H, vinyl —CH═CH₂), 5.26 (dd, J=1.4 Hz, 17.2 Hz, 1H, trans vinyl —CH═CH₂), 5.17 (dd, J=1.0 Hz, 10.4 Hz, 1H, cis vinyl —CH═CH₂), 4.01 (d, J=5.7 Hz, 2H, —O—CH₂—CH═CH₂), 3.44-3.82 (m, 206H, PEG backbone), 3.37 (s, 3H, H₃C—O—); ¹³C-NMR (CDCl₃) δ 134.9, 117.2, 72.4, 72.1, 70.7, 69.6, 59.1; FT-IR, ν (cm⁻¹) 2878, 1466, 1456, 1359, 1341, 1279, 1240, 1145, 1098, 1060, 957, 947, 842; GPC (DMF+LiBr) Mₙ=1.8 kDa, PDI=1.04. MALDI-TOF MS: molecular ion centered at 2.0 kDa.

MeO-PEG5 kDa-Allyl:

5.00 g (1 mmol) Poly (ethylene glycol) methyl ether (Mₙ=5 kDa) were reacted according to the general procedure (I) and the product was obtained as a white solid (4.45 g), 88% yield. ¹H-NMR (CDCl₃): δ 5.86-5.95 (m, 1H, —CH═CH₂), 5.26 (d, J=17.3 Hz, 1H, trans vinyl —CH═CH₂), 5.17 (d, J=10.3 Hz, 1H, cis vinyl —CH═CH₂), 4.01 (d, J=5.3 Hz, 2H, —O—CH₂—CH═CH₂), 3.44-3.82 (m, 553H, PEG backbone), 3.37 (s, 3H, H₃C—O—); ¹³C-NMR (CDCl₃) δ 134.9, 117.2, 72.3, 72.0, 70.7, 69.5, 59.1; FT-IR, ν (cm⁻¹) 2881, 1466, 1360, 1341, 1279, 1240, 1147, 1098, 1060, 959, 842; GPC (DMF+LiBr): Mₙ=5.7 kDa, PDI=1.02.

MeO-PEG10 kDa-Allyl:

2.00 g (0.2 mmol) Poly (ethylene glycol) methyl ether (Mₙ=10 kDa) were reacted according to the general procedure (I) and the product was obtained as a white solid (1.98 g). ¹H-NMR (CDCl₃): δ 5.82-5.95 (m, 1H, —CH═CH₂), 5.25 (dd, J=1.4 Hz, 17.2 Hz, 1H, trans vinyl —CH═CH₂), 5.15 (dd, J=1.1 Hz, 10.3 Hz, 1H, cis vinyl —CH═CH₂), 4.00 (d, J=5.6 Hz, 2H, —O—CH₂—CH═CH₂), 3.43-3.81 (m, 956H, PEG backbone), 3.35 (s, 3H, H₃C—O—); ¹³C-NMR (CDCl₃) δ 134.9, 117.2, 72.3, 72.0, 71.1, 70.7, 69.5, 59.1; FT-IR, ν (cm⁻¹): 2881, 1467, 1454, 1360, 1341, 1279, 1240, 1147, 1098, 1060, 960, 948, 842; GPC (DMF+LiBr): Mₙ=11.2 kDa, PDI=1.02.

### General Procedure for Compounds 2a-c

MeO-PEG-Allyl was dissolved in MeOH (5 mL per 1 g). Cystamine hydrochloride (40 eq.) and DMPA (0.2 eq.) were added. The solution was purged with nitrogen for 15 minutes and then placed under UV light at 365 nm for 2 hours. MeOH was evaporated to dryness and the crude mixture was dissolved in NaOH 1N (100 mL per 1 g). This aqueous phase was extracted with DCM (3×50 mL). The organic phase was filtered through celite and evaporated in vacuum. The residue was re-dissolved in DCM (5 mL per 1 g PEG) and product was precipitated by the dropwise addition of 1:1 v/v Ether:Hexane mixture (50 mL per 1 g PEG). The white precipitate was filtered and washed with ether and then with hexane and was dried under high vacuum.

2a: 2.00 g (0.97 mmol) MeO-PEG2k-Allyl were reacted according to the general procedure (II) and the product was obtained as a white solid (1.70 g, 82% yield) ¹H-NMR (CDCl₃): δ 3.44-3.82 (m, 225H, PEG backbone), 3.37 (s, 3H, H₃C—O—), 2.86 (t, J=6.3 Hz, 2H, —CH₂—NH₂), 2.56-2.62 (m, 4H, —CH₂—S—CH₂—), 1.85 (qui, J=6.7 Hz, 2H, —O—CH₂—CH₂—CH₂—S—); ¹³C-NMR (CDCl₃) δ 72.1, 70.7, 70.4, 69.8, 59.2, 41.3, 36.4, 30.0, 28.6; FT-IR ν (cm⁻¹): 2883, 1467, 1456, 1360, 1343, 1280, 1241, 1146, 1115, 1061, 963, 947, 842; GPC (DMF+LiBr): Mₙ=1.8 kDa, PDI=1.04.

2b: 2.12 g (0.42 mmol) MeO-PEG5k-Allyl were reacted according to the general procedure (II) and the product was obtained as a white solid (2.02 g, 94% yield). ¹H-NMR (CDCl₃): δ 3.45-3.83 (m, 590H, PEG backbone), 3.38 (s, 3H, H₃C—O—), 2.87 (t, J=6.2 Hz, 2H, —CH₂—NH₂), 2.57-2.63 (m, 4H, —CH₂—S—CH₂—), 1.82-1.89 (m, 2H, —O—CH₂—CH₂—CH₂—S—); ¹³C-NMR (CDCl₃): δ 72.1, 70.7, 70.3, 69.4, 59.2, 40.6, 36.4, 29.8, 28.5; FT-IR ν (cm⁻¹): 2882, 1542, 1466, 1360, 1341, 1279, 1240, 1146, 1102, 1060, 959, 842; GPC (DMF+LiBr): Mₙ=5.6 kDa, PDI=1.04.

2c: 500 mg (0.05 mmol) MeO-PEG10k-Allyl were reacted according to the general procedure (II) and the product was obtained as a white solid (434 mg) 86% yield. ¹H-NMR (CDCl₃): δ 3.43-3.81 (m, 1152H, PEG backbone), 3.36 (s, 3H, H₃C—O—), 2.87 (t, J6.4=Hz, 2H, —CH₂—NH₂), 2.53-2.66 (m, 4H, —CH₂—S—CH₂—), 1.84 (qui, J=6.7 Hz, 2H, —O—CH₂—CH₂—CH₂—S—); ¹³C-NMR (CDCl₃) δ 72.0, 71.2, 70.7, 69.7, 59.1, 41.1, 35.9, 29.9, 28.5; FT-IR ν (cm⁻¹): 2880, 1467, 1454, 1359, 1341, 1279, 1240, 1146, 1096, 1060, 960, 947, 841; GPC (DMF+LiBr): Mₙ=11.3 kDa, PDI=1.02.

### General Procedure for Compounds 4a-c

Compounds 2a-c were dissolved in DCM (10 mL per 1 g) followed by addition of compound 3 (3 eq.) and DIPEA (9 eq.) and the reaction was stirred overnight. The solvent was evaporated in vacuum and the crude mixture was loaded on a MeOH based LH20 SEC column. The fractions that contained the product were unified and the MeOH was evaporated in vacuum to yield an oily residue. In order to facilitate the removal of residual MeOH and solidification of the product, the oily residue was re-dissolved in DCM (5 mL per 1 g) followed by addition of hexane (20 mL per 1 g). DCM and hexane were evaporated to dryness and the off-white solid was dried under high vacuum.

4a: 1.27 g (0.98 mmol) 2a was reacted according to the general procedure (III) and the product was obtained as an off-white solid (1.17 g), 84% yield. ¹H-NMR (CDCl₃): δ 7.03 (d, J=2.2 Hz, 2H, arom H), 6.79 (t, J=5.2 Hz, 1H, —NH—CO—), 6.73 (t, J=2.2 Hz, 1H, arom H), 4.71 (d, J=2.3 Hz, 4H, —O—CH₂—C≡CH), 3.44-3.82 (m, 213H, PEG backbone), 3.37 (s, 3H, H₃C—O—), 2.76 (t, J=6.4 Hz, 2H, —S—CH₂—), 2.64 (t, J=7.2 Hz, 2H, —CH₂—S—), 2.56 (t, J=2.3 Hz, 2H, —C≡CH), 1.86 (qui, J=6.6 Hz, 2H, —O—CH₂—CH₂—CH₂—S—) ¹³C-NMR (CDCl₃) δ 166.9, 158.9, 137.0, 106.8, 105.6, 78.2, 76.2, 72.1, 70.7, 70.3, 69.5, 59.2, 56.3, 39.0, 31.8, 29.8, 28.4; FT-IR ν (cm⁻¹): 2882, 1593, 1466, 1455, 1359, 1341, 1279, 1241, 1146, 1103, 1060, 960, 947, 842; GPC (DMF+LiBr): Mₙ=2.0 kDa, PDI=1.03. MALDI-TOF MS: molecular ion centered at 2.3 kDa.

4b: 1.20 g (0.23 mmol) 2b were reacted according to the general procedure (III) and the product was obtained as an off-white solid (1.10 g), 90% yield. ¹H-NMR (CDCl₃): δ 7.04 (d, J=2.1 Hz, 2H, arom H), 6.76-6.81 (m, 1H, —NH—CO—), 6.74 (t, J=2.1 Hz, 1H, arom H), 4.72 (d, J=2.2 Hz, 4H, —O—CH₂—C≡CH), 3.45-3.83 (m, 567H, PEG backbone), 3.38 (s, 3H, H₃C—O—), 2.77 (t, J=6.4 Hz, 2H, —S—CH₂—), 2.65 (t, J=7.0 Hz, 2H, —CH₂—S—), 2.57 (t, J=2.2 Hz, 2H, —C≡CH), 1.87 (qui, J=6.7 Hz, 2H, —O—CH₂—CH₂—CH₂—S—); ¹³C-NMR (CDCl₃) δ 166.9, 158.8, 136.9, 106.8, 105.6, 78.2, 76.2, 72.1, 70.7, 70.3, 69.5, 59.1, 56.3, 39.0, 31.8, 29.8, 28.4; FT-IR ν (cm⁻¹): 2883, 1654, 1593, 1542, 1467, 1360, 1342, 1279, 1240, 1147, 1107, 1061, 961, 842; GPC (DMF+LiBr): Mₙ=6.2 kDa, PDI=1.03. MALDI-TOF MS: molecular ion centered at 5.5 kDa.

4c: 200 mg (0.02 mmol) 2c were reacted according to the general procedure (III) and the product was obtained as an off-white solid (202 mg, quantitative yield). ¹H-NMR CDCl₃) δ 7.02 (d, J=2.3 Hz, 2H, arom H), 6.77 (t, J=5.6 Hz, 1H, —NH—CO—), 6.72 (t, J 2.3 Hz, 1H, arom H), 4.69 (d, J=2.4 Hz, 4H, —O—CH₂—C≡CH), 3.42-3.80 (m, 1089H, PEG backbone), 3.35 (s, 3H, H₃C—O—), 2.74 (t, J=6.5 Hz, 2H, —S—CH₂—), 2.63 (t, J=7.2 Hz, 2H, —CH₂—S—), 2.55 (t, J=2.4 Hz, 2H, —C≡CH), 1.84 (qui, J=6.7 Hz, 2H, —O—CH₂—CH₂—CH₂—S—); ¹³C-NMR (CDCl₃) δ 166.8, 158.8, 136.9, 106.8, 105.6, 78.1, 76.2, 72.0, 71.1, 70.6, 69.8, 69.4, 59.1, 56.2, 39.0, 31.7, 29.7, 28.3; FT-IR ν (cm′): 2880, 1593, 1359, 1467, 1454, 1341, 1279, 1241, 1146, 1096, 1060, 960, 947, 841; GPC (DMF+LiBr): Mₙ=11.8 kDa, PDI=1.03.

### General Procedure for Compounds 6a-c

Compounds 4a-c were dissolved in MeOH (5 mL per 1 g). 2-(Boc-amino)-ethanethiol (80 eq.) and DMPA (0.8 eq.) were added. The solution was purged with nitrogen for 15 minutes and then placed under UV light at 365 nm for 2 hours. MeOH was evaporated to a dryness and the crude was loaded on a MeOH based LH20 SEC column. The fractions that contained the product were unified and the MeOH was evaporated in vacuum to yield an oily residue. In order to facilitate the removal of residual MeOH and solidification of the product, the oily residue was re-dissolved in DCM (5 mL per 1 g) followed by addition of Hexane (20 mL per 1 g). DCM and hexane were evaporated to dryness and the off-white solid was dried under high vacuum.

6a: 300 mg (0.13 mmol) 4a were reacted according to the general procedure (IV) and the product was obtained as an off-white solid (357 mg, 91% yield). ¹H-NMR (CDCl₃): δ 6.96-7.04 (m, 3H, arom H+—NH—CO—), 6.58-6.64 (m, 1H, arom H) 5.07-5.25 (m, 4H, —NH-(Boc)), 4.12-4.30 (m, 4H, arom-O—CH₂—), 3.45-3.82 (m, 258H, PEG backbone), 3.37 (s, 3H, H₃C—O—), 3.24-3.35 (m, 8H, —CH₂—NH(Boc)), 3.09-3.19 (m, 2H, —CH—S—), 2.87-2.99 (m, 4H, —CH—CH₂—S—), 2.72-2.87 (m, 6H, —S—CH₂—+—S—CH₂—), 2.59-2.72 (m, 6H, —CH₂—S—+—CH₂—S—), 1.43 (s, 36H, Boc); ¹³C-NMR (CDCl₃) δ 166.9, 159.5, 156.0, 155.9, 136.8, 106.2, 104.9, 79.4, 71.9, 70.6, 70.2, 69.7, 69.5, 59.0, 45.0, 40.5, 40.1, 39.3, 34.4, 33.0, 32.0, 31.5, 29.6, 28.5, 28.3; FT-IR ν (cm-1): 2883, 1712, 1592, 1521, 1452, 1391, 1361, 1341, 1279, 1239, 1101, 945, 842; GPC (DMF+LiBr): Mₙ=2.5 kDa, PDI=1.04.

6b: 1.01 g (0.19 mmol) 4b were reacted according to the general procedure (IV) and the product was obtained as an off-white solid (1.09 g, 95% yield). ¹H-NMR (CDCl₃): δ 6.92-7.04 (m, 3H, arom H+—NH—CO—), 6.55-6.62 (m, 1H, arom H) 5.15-5.28 (m, 2H, —NH-(Boc)), 5.03-5.15 (m, 2H, —NH-(Boc)), 4.10-4.27 (m, 4H, arom-O—CH₂—), 3.42-3.80 (m, 590H, PEG backbone), 3.21-3.37 (m, 11H, H₃C—O—+—CH₂—NH(Boc)), 3.07-3.19 (m, 2H, —CH—S—), 2.83-2.98 (m, 4H, —CH—CH₂—S—), 2.70-2.83 (m, 6H, —S—CH₂—+—S—CH₂—), 2.55-2.70 (m, 6H, —CH₂—S—+—CH₂—S—), 1.85 (qui, J=6.7 Hz, 2H, —O—CH₂—CH₂—CH₂—S—), 1.41 (s, 36H, Boc); ¹³C-NMR (CDCl₃) δ 167.0, 159.6, 156.0, 155.9, 136.8, 106.2, 105.0, 79.5, 72.0, 71.8, 70.6, 70.3, 69.8, 69.5, 59.1, 45.1, 40.5, 40.2, 39.3, 34.5, 33.1, 32.1, 31.6, 29.7, 28.5, 28.4; FT-IR ν (cm-1): 2868, 1706, 1648, 1592, 1522, 1455, 1390, 1364, 1348, 1272, 1250, 1096, 947, 846; GPC (DMF+LiBr): Mₙ=7.2 kDa, PDI=1.03. MALDI-TOF MS: molecular ion centered at 6.0 kDa.

6c: 167 mg (0.02 mmol) 4c were reacted according to the general procedure (IV) and the product was obtained as an off-white solid (170 mg, quantitative yield). ¹H-NMR (CDCl₃): δ 6.92-7.03 (m, 3H, arom H+—NH—CO—), 6.55-6.62 (m, 1H, arom H), 5.04-5.26 (m, 4H, —NH-(Boc)), 4.13-4.27 (m, 4H, arom-O—CH₂—), 3.42-3.80 (m, 1225H, PEG backbone), 3.35 (s, 3H, H₃C—O—), 3.22-3.33 (m, 8H, —CH₂—NH(Boc)), 3.19-3.22 (m, 2H, —CH—S—), 2.85-2.96 (m, 4H, —CH—CH₂—S—), 2.72-2.77 (m, 6H, —S—CH₂—+—S—CH₂—), 2.61-2.70 (m, 6H, —CH₂—S—+—CH₂—S—), 1.85 (qui, J=6.6 Hz, 2H, —O—CH₂—CH₂—CH₂—S—), 1.41 (s, 36H, Boc); ¹³C-NMR (CDCl₃) δ 167.0, 159.7, 156.03, 155.99, 136.9, 106.3, 105.1, 79.6, 72.1, 70.7, 70.4, 70.3, 69.9, 69.6, 59.1, 45.2, 40.6, 40.2, 39.4, 34.6, 33.1, 32.2, 31.6, 29.8, 28.6, 28.5; FT-IR ν (cm⁻¹): 2880, 1710, 1592, 1467, 1454, 1360, 1341, 1279, 1241, 1146, 1097, 1060, 960, 947, 841; GPC (DMF+LiBr): Mₙ=12.8 kDa, PDI=1.02.

### General Procedure for the Amphiphilic Hybrids 1a-c

Compounds 6a-c are dissolved in a suitable solvent and TFA was added. After 30 minutes the solution is evaporated to dryness and dried in vacuum. Compounds 7a-c are re-dissolved in a suitable solvent, an agrochemical derivative 8 capable of reacting with the amino groups of 7a-c is added and the reaction is allowed to stir overnight. The solvent is evaporated to dryness and the crude mixture is purified by column chromatography.

### Synthesis of 4-nitrophenyl 3,5-bis(prop-2-yn-1-yloxy) benzoate (3)

3,5-bis(prop-2-yn-1-yloxy) benzoic acid (1.70 gr, 7.4 mmol) and 4-nitrophenol (1.13 g, 8.12 mmol, 1.1 eq) were dissolved in EtOAc (20 ml). Flask was cooled to 0° C. and DCC (1.68 g, 8.12 mmol, 1.1 eq) was added. After 3 hours the solution was filtered off and EtOAc was removed in vacuum. Crude mixture was purified by a silica column using 100% DCM as an eluent and the product was obtained as white solid in 71% yield (1.84 gr) ¹H-NMR (CDCl₃) δ 8.33 (d, J=9.0 Hz, 2H, arom H), 7.45 (d, J=2.2 Hz, 2H, arom H), 7.41 (d, J=9.0 Hz, 2H, arom H), 6.93 (t, J=2.2 Hz, 1H, arom H), 4.76 (d, J=2.2 Hz, 4H, —O—CH₂—C≡CH), 2.57 (t, J=2.2 Hz, ¹³C-NMR (CDCl₃): δ 163.8, 159.0, 155.8, 145.7, 130.7, 125.5, 122.7, 109.9, 108.7, 77.9, 76.4, 56.4; FT-IR, ν (cm⁻¹) 3270, 2117, 1747, 1610, 1590, 1522, 1506, 1491, 1469, 1451, 1387, 1357, 1335, 1294, 1271, 1216, 1202, 1161, 1115, 1093, 1068, 1029, 992, 948, 937, 910, 895, 859, 844, 814; HR-MS (ESI) calculated for C₁₉H₁₄NO₆ 352.0816 (MH⁺), found 352.0817.

### Example 4: Synthesis of Amphiphilic PEG-Dendron Hybrids

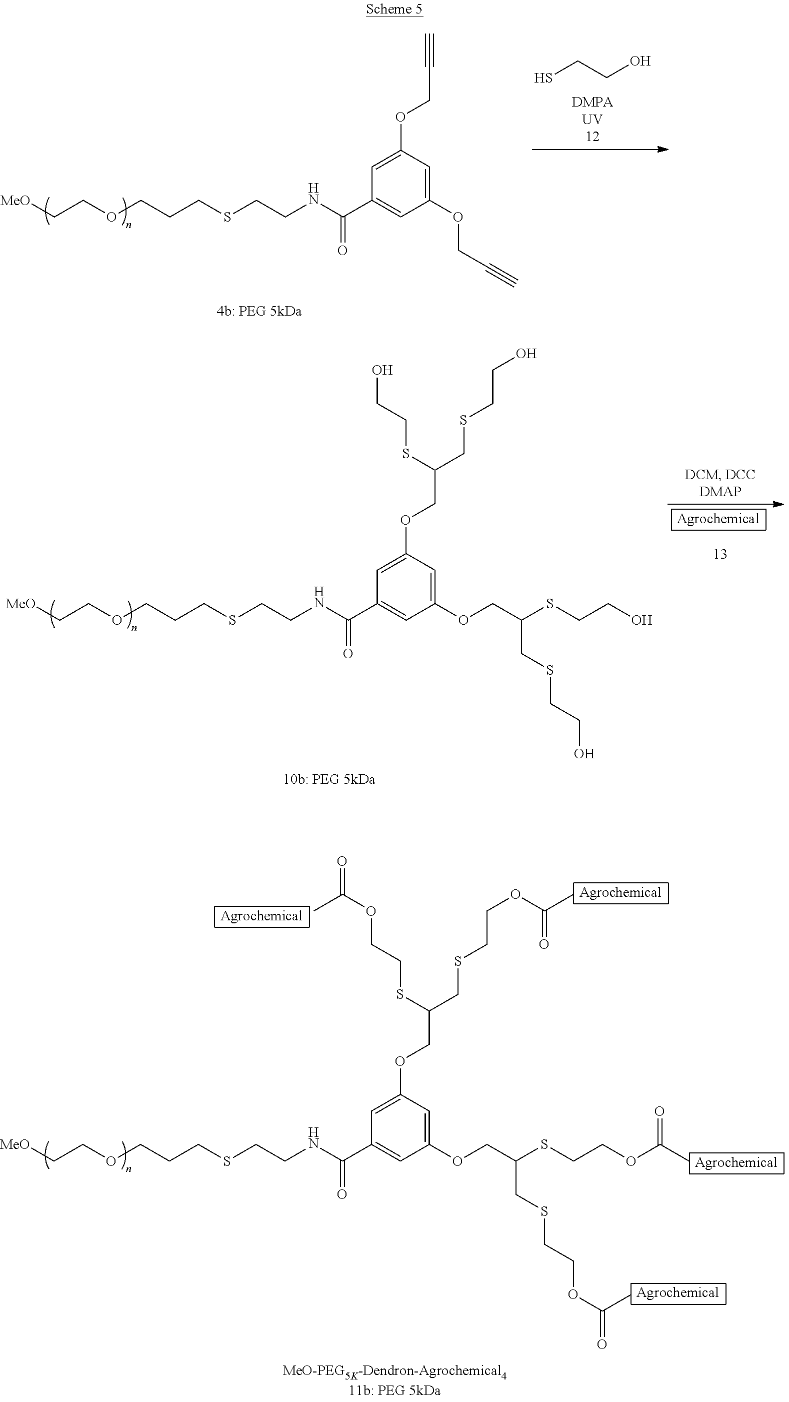

The compound 11b of the invention may be prepared by the process described in general Scheme 5 hereinabove. Briefly, the hybrid block copolymers are synthesized utilizing mono-methyl ether PEG-amine, 2b, prepared as described in Example 3. Conjugation of compound 2b with an active ester of 3,5-bis(prop-2-yn-1-yloxy)benzoic acid yields PEG-di-yne, 4b. The latter is further modified by thiol-yne reaction with 2-mercaptoethanol, 12, to give tetra-functionalized PEG-dendron, 10b. In the last step of the synthesis, an agrochemical is introduced to the enzyme or pH-cleavable hydrophobic surface-groups to obtain the PEG-dendron hybrids.

Similar reactions are performed with 2 kDa PEG and 10 kDa PEG to yield the corresponding PEG-dendron hybrids 11a and 11c, respectively.

10b: PEG-di acetylene derivative 4b (418 mg, 78.42 μmol) was dissolved in MeOH (2.5 ml). 2-Mercaptoethanol, 12 (80 eq.) and DMPA (0.8 eq.) were added. The solution was purged with nitrogen for 15 minutes and then placed under UV light at 365 nm for 2 hours. MeOH was evaporated to a dryness and the crude was loaded on a MeOH based LH20 SEC column. The fractions that contained the product were unified and the MeOH was evaporated in vacuum to yield an oily residue. In order to facilitate the removal of residual MeOH and solidification of the product, the oily residue was re-dissolved in DCM (5 mL per 1 g) followed by addition of hexane (20 mL per 1 g). DCM and hexane were evaporated to dryness and the off-white solid was dried under high vacuum (386 mg, 87% yield). ¹H-NMR (CDCl₃): δ 7.1 (m, 1H—NH—CO—), 7.00 (m, 2H, arom H) 6.62 (m, 1H, arom H), 4.17-4.28 (m, 4H, arom-O—CH₂—), 3.43-3.89 (m, 535H, PEG backbone+H₂C—OH), 3.36 (s, 3H, H₃C—O—), 3.26-3.29 (m, 2H, —CH—S—), 2.73-3.01 (m, 14H, —CH—CH₂—S—+—S—CH₂—), 2.64 (t, J=7.2 Hz, 2H, —CH₂—S—) 1.85 (qui, J=6.7 Hz, 2H, —O—CH₂—CH₂—CH₂—S—); ¹³C-NMR (CDCl₃) δ 167.2, 159.6, 136.9, 106.3, 105.4, 72.0, 70.7, 70.3, 70.2, 69.5, 61.8, 61.2, 60.5, 59.1, 45.4, 41.4, 39.3, 36.3, 35.3, 35.0, 31.7, 29.8, 29.7, 28.5; FT-IR ν (cm⁻¹): 2889, 1592, 1541, 1468, 1360, 1341, 1279, 1240, 1105, 945, 842; GPC (DMF+LiBr): Mₙ=7.1 kDa, PDI=1.03.

11b: 10b is dissolved in a suitable solvent, and an agrochemical derivative capable of reacting with the hydroxyl group of 10b is added and the reaction is allowed to stir overnight. The solvent is evaporated to dryness and the crude mixture is purified by column chromatography.

Utilizing the modular platform described above, hybrids of various PEG lengths are prepared with dendrimers of different generations in order to study their self-assembly and ability to disassemble upon cleavage of their 2,4-D hydrophobic end-groups. The self-assembly, the release of 2,4-D and disassembly of the proposed hybrid amphiphiles in aqueous buffer solutions will be studied using the methodologies described in example 1, including:

Dynamic light scattering (DLS) which used to determine the size (hydrodynamic radius) of the self-assembled structures. DLS is also be used to monitor the disassembly of the expected micellar structures into their polymeric building blocks upon addition of the activating enzyme.

Fluorescence spectroscopy of encapsulated dyes is utilized to determine the CMC of the amphiphilic PEG-dendrimer hybrids. The fluorescence of dyes such as pyrene and Nile red is strongly influenced by the hydrophobicity of their environment and therefore is used to determine the formation of micelles and other assemblies with hydrophobic cores. Furthermore, this technique is also be used to demonstrate the expected decrease in hydrophobicity and consequent release of these hydrophobic dyes upon hydrolysis of 2,4-D end-groups and disassembly.

¹H-NMR is used to determine the formation of self assemble structures with core-shell morphologies. The spectra of the proposed hydrophilic hydroxyl terminated PEG dendrimer precursors in D20 are expected to show peaks of both the protons of the PEG and hydrophilic dendrimer. In contrast, the spectrum of the amphiphilic hybrid is shows only the peaks of the PEG, demonstrating the formation of self-assembled structures with PEG shells and dendrimers based hydrophobic cores. ¹H-NMR could also potentially used to study the kinetics of the self-assembly by monitoring the appearance and increase in intensity of the peaks that correspond to the dendrimer.

Electron microscopy (TEM, cryoTEM and SEM) and atomic force microscopy (AFM) is used to in addition to the DLS in order to obtain information of the size and shape of the assembled structures.

HPLC is used to characterize the hydrolysis of the proposed amphiphilic PEG dendrimer hybrids and the release of 2,4,-D. Taking advantage of the monodispersity of the propose hybrids, we can assume to have finite and distinctive number of possible intermediates during the hydrolysis process (e.g. PEG-G2-Dendrimers with four, three, two, one or without hydrophobic end-groups). Direct analysis of the formation of such intermediates, which cannot be possible using linear block copolymers due to their polydispersity, could give important information and great insight into the disassembly mechanism.

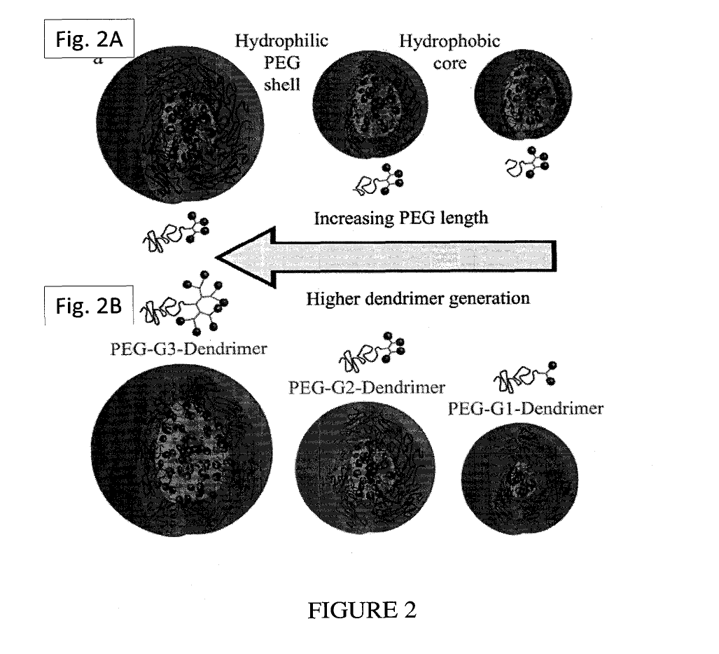

The use of the above mentioned characterization techniques is used to evaluate the potential of the novel molecular design of the invention to serve as a platform for the preparation of smart supramolecular assemblies with controllable sizes (FIGS. 2a and 2b). The precise control over the molecular structure of the individual PEG-dendrimer hybrids allows control of the release and disassembly rates by tuning the molecular parameters (PEG length, dendrimers structure and their ratio).

The hydrophobic cores of smart self-assembled micelles can be exploited to encapsulate hydrophobic herbicides that cannot be covalently bound to the dendrimer. These encapsulated herbicides can be released from these micelle-based nanocarriers upon introduction of the activating stimuli and hydrolysis of the hydrophobic end-groups of the dendrimer. Such responsive nanocarriers have great potential due to their ability to release a combination of herbicides in a highly controlled manner Based on the proposed molecular design, 2,4-D are used as end-groups and study the ability of the self-assembled structures to be loaded with various hydrophobic herbicides (such as pendimethalin or oxyfluorfen) and release them upon external stimuli.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1-47. (canceled)

48. An amphiphilic hybrid delivery system in micellar form for the delivery of agrochemicals, comprising a hydrophilic polyethylene glycol (PEG) polymer conjugated to a hydrophobic dendron, the dendron comprising at least one enzymatically or pH-dependent cleavable hydrophobic end group that is covalently attached to the dendron, wherein said micelle comprises an agrochemical either as part of the hydrophobic end group, or encapsulated within the micelle, or both, and wherein said micelle disassembles to release the agrochemical upon enzymatic or pH-dependent cleavage of said hydrophobic end group.

49. The hybrid delivery system according to claim 48, wherein the hydrophobic end group is or is derived from an agrochemical, or wherein the hydrophobic end group is biologically inactive.

50. The hybrid delivery system according to claim 48, further comprising a second agrochemical encapsulated within the micelle, wherein said second agrochemical is released upon disassembly of said micelle.

51. The hybrid delivery system according to claim 50, wherein the hydrophobic end group which is attached to said dendron and the agrochemical which is encapsulated within said micelle are the same, or wherein the hydrophobic end group which is attached to said dendron and the agrochemical which is encapsulated within said micelle are different.

52. The hybrid delivery system according to claim 48, wherein the hydrophobic dendron comprises:
a first generation which is covalently bound to the PEG polymer, directly or through a linker or branching unit, and comprises at least one functional group capable of binding to a further generation or to said hydrophobic end group; and
optionally, at least one additional generation which is covalently bound to said first generation or preceding generation, and optionally to a further generation, wherein each of said optional generations comprises at least one functional group capable of binding to said first generation or preceding generation, to a further generation, and/or to said hydrophobic end group, each of said bonds being formed directly or through a linker or branching unit.

53. The hybrid delivery system according to claim 48, wherein each generation of the hydrophobic dendron comprises a linear or branched C1-C20 alkylene, C2-C20 alkenylene, C2-C20 alkynylene or arylene which is substituted at each end with a group selected from the group consisting of —S—, —O—, —NH—, —C(═O)—, —C(═O)—O—, —O—C(═O)—O—, —C(═O)—NH—, —NH—C(═O)—NH—, —NH—C(═O)—O—, —S(═O)—, —S(═O)—O—, PO(═O)—O— and any combination thereof.

54. The hybrid delivery system according to claim 53, wherein each generation of the dendron is derived from a compound selected from the group consisting of HX—CH₂—CH₂—XH, HX—(CH₂)₁₋₃—CO₂H and HX—CH₂—CH(XH)—CH₂—XH wherein X is independently at each occurrence S, O or NH.

55. The hybrid delivery system according to claim 54, wherein each generation of the dendron is derived from a compound selected from the group consisting of HS—CH₂—CH₂—OH, HS—(CH₂)₁₋₃—CO₂H and HS—CH₂—CH(OH)—CH₂—OH.

56. The hybrid delivery system according to claim 48, further comprising a linker moiety or branching unit which connects the PEG polymer to the first generation dendron and/or which forms a part of the first generation dendron, and/or which connects between dendron generations.

57. The hybrid delivery system according to claim 56, wherein the linker moiety/branching unit is selected from a group consisting of a substituted or unsubstituted acyclic, cyclic or aromatic hydrocarbon moiety, heterocyclic moiety, a heteroaromatic moiety or any combination thereof.

58. The hybrid delivery system according to claim 57, wherein the linker moiety/branching unit is a substituted arylene.

59. The hybrid delivery system according to claim 56, wherein the linker moiety/branching unit is connected to the PEG or to the dendron through a functional group selected from the group consisting of —O—, —S—, —NH—, —C(═O)—, —O—C(═O)—O—, —C(═O)—O—, —C(═O)—NH—, —NH—C(═O)—NH—, —NH—C(═O)—O—, —S(═O)—, —S(═O)—O—, PO(═O)—O—, —C═C—, —C≡C—, —(CH₂)ₜ— wherein t is an integer of 1-10, and any combination thereof.

60. The hybrid delivery system according to claim 48, wherein the hydrophobic end group is cleaved by an enzyme which is (i) present in greater amount at; or (ii) produced in greater quantity at, or (iii) has higher activity at the delivery site of said agrochemical.

61. The hybrid delivery system according to claim 48, wherein the hydrophobic end group is conjugated to the dendron through a pH-sensitive or enzymatically cleavable functional group selected from the group consisting of an ester, an amide, a carbamate, a carbonate, a urea, a sulfate, an amidine, an ether, a phosphate, a phosphoamide, sulfamates, and a trithionate.

62. The hybrid delivery system according to claim 48, wherein the hydrophobic end group is conjugated to the dendron through an amide which is cleavable by an amidase, wherein the amidase is selected form the group of aryl-acylamidase, aminoacylase, alkylamidase, and phthalyl amidase.

63. The hybrid delivery system according to claim 48, wherein the hydrophobic end group is conjugated to the dendron through an ester which is cleavable by an esterase, wherein the esterase is selected from the group consisting of carboxylesterase, arylesterase, and acetylesterase.

64. The hybrid delivery system according to claim 48, wherein the hydrophobic end group is conjugated to the dendron through a functional group that is hydrolyzed upon a change in the pH in the environment surrounding the delivery site of the system.

65. The hybrid delivery system according to claim 64, wherein the hydrophobic end group is conjugated to the dendron through a pH-sensitive functional group selected from the group consisting of an ester, an amide, an anhydride, an imide, a carbonate, a carbamate, a thiocarbamate, a urea, sulfonylurea, an acetal, a ketal, a hemiacetal, a hemiketal, an amidine, a guanidine, a silyl ether, an imine, an enamine, a hydrazone, an oxime, a phosphate, a phosphorothionate, a phosphoroamide, a sulfonamide, and a trithionate.

66. The hybrid delivery system according to claim 48, wherein the hydrophobic end group which is attached to the dendron and the agrochemical which is encapsulated by said micelle are each or are each derived from an agrochemical independently selected from the group consisting of a pesticide, an insecticide, a herbicide, a fungicide, an acaricide, an algicide, an antimicrobial agent, biopesticide, a biocide, a disinfectant, a fumigant, an insect growth regulator, a plant growth regulator, a miticide, a microbial pesticide, a molluscide, a nematicide, an ovicide, a pheromone, a repellent, a rodenticide, a defoliant, a dessicant, a termiticide, a piscicide, avicide, rodenticide, bactericide, insect repellent, an auxin, a cytokinin, a gametocide, a gibberellin, a growth inhibitor, a growth stimulator and any combination thereof.

67. The hybrid delivery system according to claim 66, wherein the hydrophobic end group which is attached to the dendron and the agrochemical which is encapsulated by said micelle are each or are each derived from an agrochemical independently selected from the group consisting of 2,4-dichlorophenoxyacetic acid, abscisic acid, indole acetic acid, 2,4,5-trichlorophenoxyacetic acid, salicylic acid, 2,3,6-trichlorobenzoic acid, benzoylprop, carfentrazone, chlorfenprop, cloquintocet, diclofop, diethatyl, fenoxaprop, fluoroglycofen, haloxyfop, iodosulfuron, MCPB, quizalofop-p, bufencarb, ethiofencarb, fenobucarb, clofibric acid, α-naphthaleneacetic acid, gibberellic acid, jasmonic acid, and derivatives thereof.

68. The hybrid delivery system according to claim 66, wherein
the insecticide is selected from the group consisting of a benzoyl urea, novaluron, lufenuron, chlorfluazuron, flufenoxuron, hexaflumuron, noviflumuron, teflubenzuron, triflumuron, diflubenzuron; a carbamate, a pyrethroid, cyhalothrin and isomers thereof, lambda-cyhalothrin, deltamethrin, tau-fluvalinate, cyfluthrin, beta-cyfluthrin, tefluthrin, bifenthrin; an organophosphate, azinfos-methyl, chlorpyrifos, diazinon, endosulfan, methidathion; a neonicotinoid, a phenylpyrazole, imidacloprid, acetamiprid, thiacloprid, dinotefuran, thiamethoxam and fipronil;
the fungicidally active compound is selected from the group consisting of a conazole, epoxiconazole, hexaconazole, propiconazole, prochloraz, imazalil, triadimenol, difenoconazole, myclobutanil, prothioconazole, triticonazole, tebuconazole, a morpholine, dimethomorph, fenpropidine fenpropimorph, a strobilurin, azoxystrobin, kresoxim-methyl, phthalonitriles, chlorothalonil; mancozeb; fluazinam; a pyrimidine and bupirimate; and
the herbicide is selected from the group consisting of an aryloxyphenoxy derivative, an aryl urea, an aryl carboxylic acid, a heteroaryl carboxylic acid, an aryloxy alkanoic acid, clodinafop-propargyl, fenoxaprop-p-ethyl, propaquizafop, quizalafop, a dintroaniline, pendimethalin, trifluralin; a diphenyl ether, oxyfluorfen, an imidazolinone, a sulfonylurea, chlorsulfuron, nicosulfuron, rimsulfuron, tribenuron-methyl, a sulfonamide, a triazine, a triazinone and metamitron.

69. The hybrid delivery system according to claim 48, wherein the hydrophobic end group which is attached to the dendron and the agrochemical which is encapsulated by said micelle are each or are each derived from an agrochemical independently selected from the group consisting of acetyl CoA carboxylase inhibitors, acetolactate synthase ALS (acetohydroxyacid synthase AHAS) inhibitors, photosynthesis at photosystem II inhibitors, photosystem-I-electron diversion inhibitors, protoporphyrinogen oxidase (PPO) inhibitors, carotenoid biosynthesis at the phytoene desaturase step (PDS) inhibitors, 4-hydroxyphenyl-pyruvate-dioxygenase (4-HPPD) inhibitors, carotenoid biosynthesis inhibitors, EPSP synthase inhibitors, glutamine synthase inhibitors, DHP (dihydropteroate) synthase inhibitors, microtubule assembly inhibitors, mitosis inhibitors, cell division inhibitors, cell wall (cellulose) synthesis inhibitors, melanin synthesis in cell wall inhibitors, uncoupling disruptors, lipid synthesis inhibitors, synthetic auxins, auxin transport inhibitors, nucleic acids synthesis inhibitors, respiration inhibitors (including: mitochondrial ATP synthase inhibitors, uncouplers of oxidative phosphorylation via disruption of the proton gradient, mitochondrial complex III electron transport inhibitors, mitochondrial complex I electron transport inhibitors, mitochondrial complex IV electron transport inhibitors, and mitochondrial complex II electron transport inhibitors), amino acids and protein synthesis inhibitors, signal transduction inhibitors, sterol biosynthesis in membranes inhibitors, host plant defence induction inhibitors, acetylcholinesterase (AChE) inhibitors, GABA-gated chloride channel antagonists, sodium channel modulators, nicotinic acetylcholine receptor (nAChR) agonists, nicotinic acetylcholine receptor (nAChR) allosteric activators, chloride channel activators, juvenile hormone mimics, miscellaneous non-specific (multi-site) inhibitors, modulators of chordotonal organs, mite growth inhibitors, microbial disruptors of insect midgut membranes, nicotinic acetylcholine receptor (nAChR) channel blockers, chitin biosynthesis type 0 and 1 inhibitors, moulting dipteran disruptor, ecdysone receptor agonists, octopamine receptor agonists, voltage-dependent sodium channel blockers, ryanodine receptor modulators and any combination thereof.

70. The hybrid delivery system according to claim 48, is represented by the structure of formula (I): 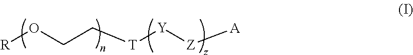
wherein
R is H or a C1-C4 alkylene group;
T is absent or is a functional group selected from the group consisting of —O—, —S—, —NH—, —C(═O)—, —O—C(═O)—O—, —C(═O)—O—, —C(═O)—NH—, —NH—C(═O)—NH—, —NH—C(═O)—O—, —S(═O)—, —S(═O)—O—, PO(═O)—O—, —C═C—, —C≡C—, —(CH₂)ₜ— wherein t is an integer of 1-10, and any combination thereof.
Y is independently at each occurrence absent or is a linker moiety/branching unit;
Z is independently at each occurrence a dendron repeating unit selected from the group consisting of: 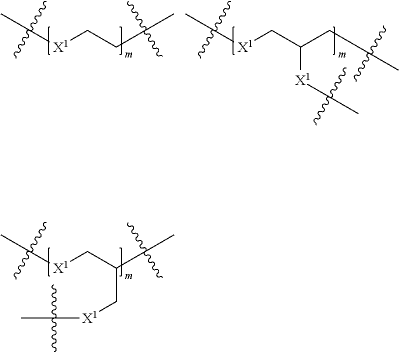
and any combination of the foregoing;
wherein X¹ is independently, at each occurrence, selected from the group consisting of a 0, S and NH;
A is a hydrophobic end group which is conjugated to the dendron through (i) an enzymatically cleavable functional group selected from the group consisting of an ester, an amide, a carbamate, a carbonate, a urea, a sulfate, an amidine, an ether, a phosphate, a phosphoamide, sulfamates, and a trithionate; or (ii) a pH-sensitive functional group selected from the group consisting of an ester, an amide, a urea, a sulfate, an amidine, an ether, a phosphate, a phosphoamide, sulfamates, and a trithionate or a pH-sensitive moiety selected from the group consisting of an ester, an amide, an anhydride, an imide, a carbonate, a carbamate, a thiocarbamate, a urea, sulfonylurea, an acetal, a ketal, a hemiacetal, a hemiketal, an amidine, a guanidine, a silyl ether, an imine, an enamine, a hydrazone, an oxime, a phosphate, a phosphorothionate, a phosphoroamide, a sulfonamide, and a trithionate;
n is an integer in the range of 1 to 1,500, preferably 1 to 1,000; and
m and z are each an integer of 1 to 15;
wherein the hydrophobic end group is or is derived from an agrochemical, or said hybrid delivery system encapsulates an agrochemical within the micelle, or a combination thereof.

71. The hybrid delivery system according to claim 70, wherein the hydrophobic end group is or is derived from an agrochemical selected from the group consisting of a pesticide, an insecticide, a herbicide, a fungicide, an acaricide, an algicide, an antimicrobial agent, biopesticide, a biocide, a disinfectant, a fumigant, an insect growth regulator, a plant growth regulator, a miticide, a microbial pesticide, a molluscide, a nematicide, an ovicide, a pheromone, a repellent, a rodenticide, a defoliant, a dessicant, a termiticide, a piscicide, avicide, rodenticide, bactericide, insect repellent, an auxin, a cytokinin, a gametocide, a gibberellin, a growth inhibitor, and a growth stimulator.

72. The hybrid delivery system according to claim 70, wherein the terminal repeating unit of said dendron is represented by any of the following structures: 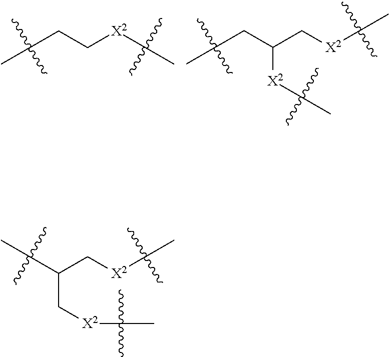
wherein X² has the same meaning as X¹.

73. The hybrid delivery system according to claim 70, wherein the hydrophobic end group A is conjugated to the dendron through a pH-sensitive or enzymatically cleavable functional group represented by the structure: 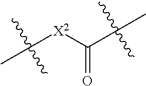
wherein X² is a part of the terminal repeating unit of said dendron and C(═O) is part of hydrophobic end group; or wherein X² is part of the hydrophobic end group and C(═O) is a part of the terminal repeating unit of said dendron; or wherein X²—C(═O) is a part of the hydrophobic end group, or wherein X²—C(═O) is part of the terminal repeating unit of said dendron; and wherein X² has the same meaning as X¹.

74. The hybrid delivery system according to claim 70, which is represented by any one or more of the following structures: 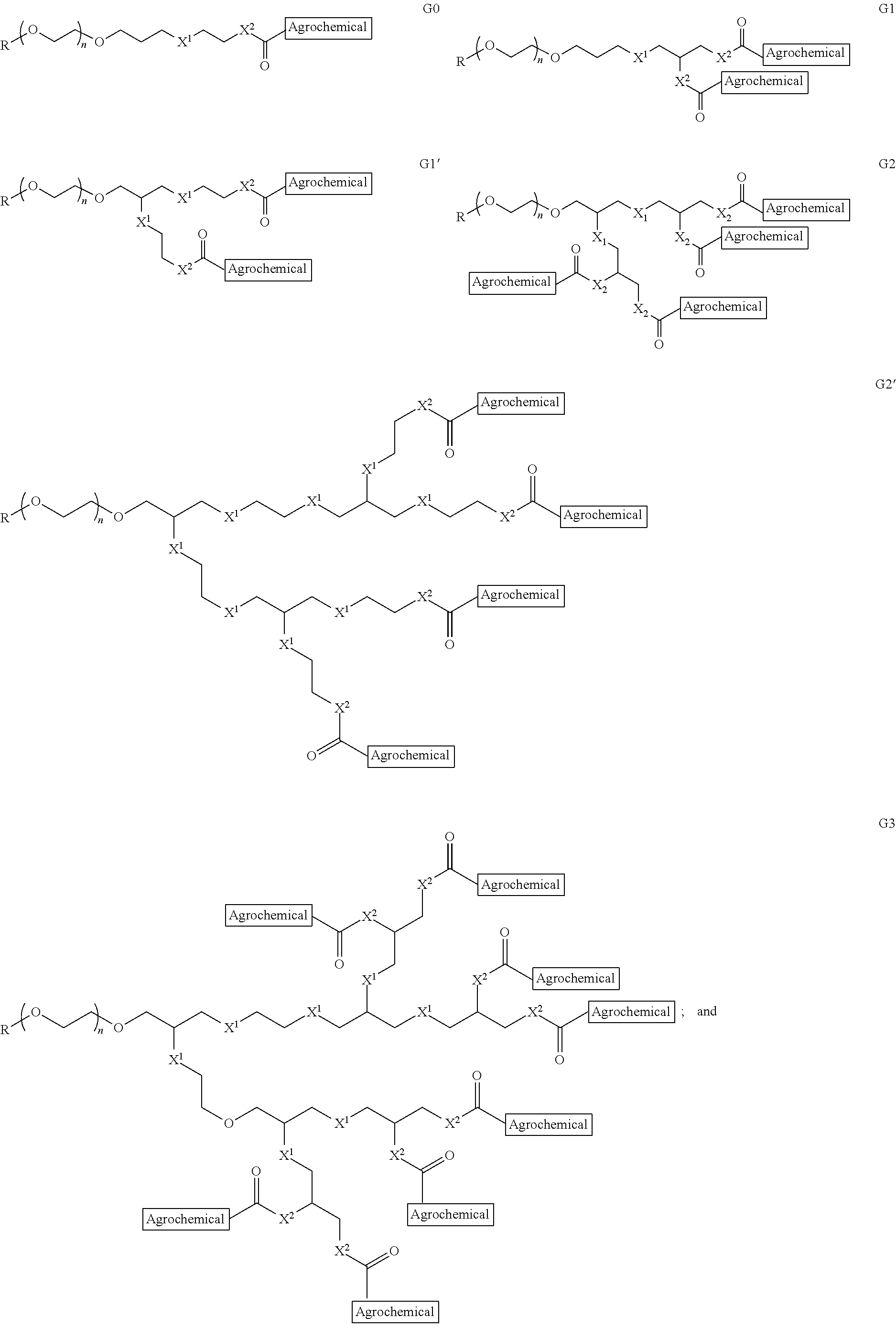 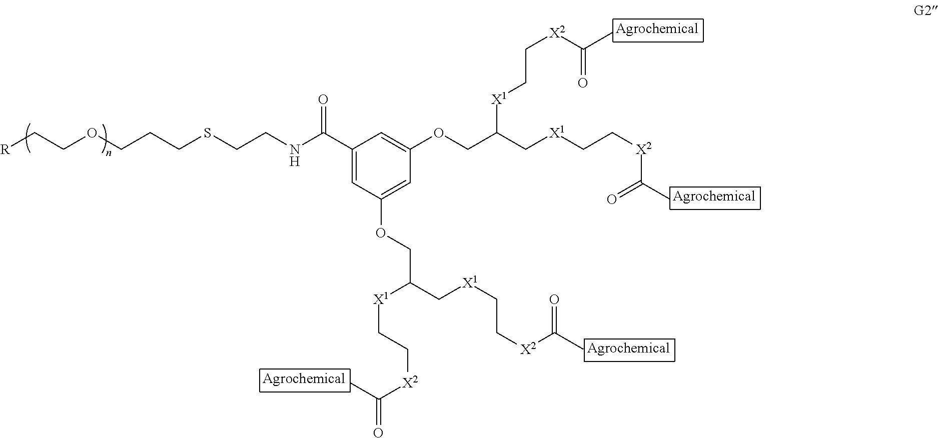
wherein each X¹ and X² is independently at each occurrence selected from the group consisting of 0, S and NH;
R is H or an C1-C4 alkylene group;
n is an integer of 1 to 1,500, preferably 1 to 1,000.

75. The hybrid delivery system according to claim 70, represented by the structure of any of compounds A, B, C, D, E, F or any of the structure of FIG. 3.

76. A method of delivering the agrochemical amphiphilic hybrid system according to claim 48, comprising the step of contacting a plant or the plant surroundings with the amphiphilic hybrid delivery system, and an enzyme or a pH adjusting agent in an amount effective to induce cleavage of the cleavable hydrophobic end group, thereby disassembling said micelle.

77. A kit for delivering the agrochemical amphiphilic hybrid system according to claim 48, comprising in one compartment the agrochemical amphiphilic hybrid system, and in a second compartment an enzyme or a pH adjusting agent capable of hydrolyzing the cleavable hydrophobic end group so as to disassemble said micelle.
